(19) United States
(12) Patent Application Publication
(10) Pub. No.: US 2026/0095581 A1
(43) Pub. Date: Apr. 2, 2026

(54) A METHOD, AN APPARATUS AND A COMPUTER PROGRAM PRODUCT FOR IMAGE AND VIDEO PROCESSING USING A NEURAL NETWORK

(71) Applicant: Nokia Technologies Oy, Espoo (FI)

(72) Inventors: Ramin GHAZNAVI YOUVALARI, Tampere (FI); Francesco CRICRÌ, Tampere (FI); Honglei ZHANG, Tampere (FI); Maria Claudia SANTAMARIA GOMEZ, Tampere (FI); Ruiying YANG, Tampere (FI); Miska Matias HANNUKSELA, Tampere (FI)

(21) Appl. No.: 19/113,743

(22) PCT Filed: Jul. 14, 2023
(86) PCT No.: PCT/EP2023/069607

§ 371 Date: Mar. 20, 2025

(30) Foreign Application Priority Data
Sep. 21, 2022 (FI) 20225818

(51) Int. Cl. H04N 19/42; H04N 19/44; H04N 19/46

(52) U.S. Cl. CPC H04N 19/42; H04N 19/44; H04N 19/46

(57) ABSTRACT

The embodiments relate to a method comprising receiving one or more data units; receiving one or more auxiliary data units; processing the data units by a first portion of a neural network based processor to generate a set of features; processing the auxiliary data units by second respective portions of the neural network based processor to generate sets of auxiliary features; determining controlling values associated to auxiliary data units or to the one or more sets of auxiliary features; controlling the auxiliary data units or the sets of auxiliary features according to the controlling values to generate sets of controlled auxiliary features; combining an output corresponding to the set of features and output corresponding to the sets of controlled auxiliary features into sets of combined features to be processed by further portions of the neural network based processor, and generating a signal comprising the one or more controlling values.

The project leading to this application has received funding from the ECSEL Joint Undertaking (JU) under grant agreement No 876019. The JU receives support from the European Union's Horizon 2020 research and innovation programme and Germany, Netherlands, Austria, Romania, France, Sweden, Cyprus, Greece, Lithuania, Portugal, Italy, Finland, Turkey.

### TECHNICAL FIELD

The present solution generally relates to image and video processing.

### BACKGROUND

One of the elements in image and video compression is to compress data while maintaining the quality to satisfy human perceptual ability. However, in recent development of machine learning, machines can replace humans when analyzing data for example in order to detect events and/or objects in video/image. The present embodiments can be utilized in Video Coding for Machines, but also in other use cases.

### SUMMARY

The scope of protection sought for various embodiments of the invention is set out by the independent claims. The embodiments and features, if any, described in this specification that do not fall under the scope of the independent claims are to be interpreted as examples useful for understanding various embodiments of the invention.

Various aspects include a method, an apparatus and a computer readable medium comprising a computer program stored therein, which are characterized by what is stated in the independent claims. Various embodiments are disclosed in the dependent claims.

According to a first aspect, there is provided an apparatus comprising means for receiving one or more data units; means for receiving one or more auxiliary data units; means for processing the one or more data units by a first portion of a neural network based processor to generate a set of features; means for processing the one or more auxiliary data units by one or more second respective portions of the neural network based processor to generate one or more sets of auxiliary features; means for determining one or more controlling values associated to the one or more auxiliary data units or to the one or more sets of auxiliary features; means for controlling the one or more auxiliary data units or the one or more sets of auxiliary features according to the one or more controlling values to generate one or more sets of controlled auxiliary features; means for combining an output corresponding to the set of features and output corresponding to the one or more sets of controlled auxiliary features into one or more sets of combined features to be processed by further one or more portions of the neural network based processor.

According to a second aspect, there is provided a method, comprising receiving one or more data units; receiving one or more auxiliary data units; processing the one or more data units by a first portion of a neural network based processor to generate a set of features; processing the one or more auxiliary data units by one or more second respective portions of the neural network based processor to generate one or more sets of auxiliary features; determining one or more controlling values associated to the one or more auxiliary data units or to the one or more sets of auxiliary features; controlling the one or more auxiliary data units or the one or more sets of auxiliary features according to the one or more controlling values to generate one or more sets of controlled auxiliary features; and combining an output corresponding to the set of features and output corresponding to the one or more sets of controlled auxiliary features into one or more sets of combined features to be processed by further one or more portions of the neural network based processor.

According to a third aspect, there is provided an apparatus comprising at least one processor, memory including computer program code, the memory and the computer program code configured to, with the at least one processor, cause the apparatus to perform at least the following: receive one or more data units; receive one or more auxiliary data units; process the one or more data units by a first portion of a neural network based processor to generate a set of features; process the one or more auxiliary data units by one or more second respective portions of the neural network based processor to generate one or more sets of auxiliary features; determine one or more controlling values associated to the one or more auxiliary data units or to the one or more sets of auxiliary features; control the one or more auxiliary data units or the one or more sets of auxiliary features according to the one or more controlling values to generate one or more sets of controlled auxiliary features; and combine an output corresponding to the set of features and output corresponding to the one or more sets of controlled auxiliary features into one or more sets of combined features to be processed by further one or more portions of the neural network based processor.

According to a fourth aspect, there is provided computer program product comprising computer program code configured to, when executed on at least one processor, cause an apparatus or a system to: receive one or more data units; receive one or more auxiliary data units; process the one or more data units by a first portion of a neural network based processor to generate a set of features; process the one or more auxiliary data units by one or more second respective portions of the neural network based processor to generate one or more sets of auxiliary features; determine one or more controlling values associated to the one or more auxiliary data units or to the one or more sets of auxiliary features; control the one or more auxiliary data units or the one or more sets of auxiliary features according to the one or more controlling values to generate one or more sets of controlled auxiliary features; and combine an output corresponding to the set of features and output corresponding to the one or more sets of controlled auxiliary features into one or more sets of combined features to be processed by further one or more portions of the neural network based processor.

According to a fifth aspect, there is provided an apparatus for decoding comprising means for receiving a signal; means for decoding information relating to one or more controlling values associated to respective one or more auxiliary data units or to respective one or more sets of auxiliary features; means for controlling the one or more auxiliary data units or the one or more sets of auxiliary features according to the one or more controlling values.

According to a sixth aspect, there is provided a method for decoding, comprising receiving a signal; decoding information relating to one or more controlling values associated to respective one or more auxiliary data units or to respective one or more sets of auxiliary features; and controlling the one or more auxiliary data units or the one or more sets of auxiliary features according to the one or more controlling values.

According to a seventh aspect, there is provided an apparatus for decoding comprising at least one processor, memory including computer program code, the memory and the computer program code configured to, with the at least one processor, cause the apparatus to perform at least the following: receive a signal; decode information relating to one or more controlling values associated to respective one or more auxiliary data units or respective one or more sets of auxiliary features; control the one or more auxiliary data units or the one or more sets of auxiliary features according to the one or more controlling values.

According to an eighth aspect, there is provided computer program product for decoding comprising computer program code configured to, when executed on at least one processor, cause an apparatus or a system to: receive a signal; decode information relating to one or more controlling values associated to respective one or more auxiliary data units or respective one or more sets of auxiliary features; control the one or more auxiliary data units or the one or more sets of auxiliary features according to the one or more controlling values.

According to an embodiment, an optimal subset of the one or more auxiliary data units or the one or more sets of the auxiliary features for neural network based processor is determined.

According to an embodiment, information relating to the optimal subset is indicated in a signal.

According to an embodiment, the one or more controlling values comprise at least one or more binary flags or gating values being associated with respective one or more auxiliary data units or respective one or more sets of auxiliary features, where each of the one or more binary flags or gating values are used to gate the respective one or more auxiliary data units or respective one or more sets of auxiliary features.

According to an embodiment, the one or more gating values comprise respective one or more identifiers, each indicating a set of auxiliary features to be used.

According to an embodiment, the one or more controlling values comprise one or more modulating values associated with respective one or more auxiliary data units or respective one or more sets of auxiliary values.

According to an embodiment, at least some of the modulating values is determined by the first set of portions of a neural network based processor, or by a third set of portions of a neural network based processor whose input comprises the one or more data units.

According to an embodiment, the one or more modulating values are comprised within a signal that is signaled from an encoder, and where the signal comprises one or more modulating values associated to respective one or more auxiliary data type; or pairs where each pair comprises an auxiliary data type and a respective modulating value; or an identifier of a set of modulating values.

According to an embodiment, the modulating values are inferred from the previously (de)coded filtering units in current frame and/or reference frame.

According to an embodiment, it is included into a signal an indication of whether to perform gating and/or an indication of whether to perform modulation based on one or more modulating values determined based on a signal from the encoder and/or an indication of whether to perform modulation based on one or more modulating values determined at decoder side.

According to an embodiment, the one or more gating values are comprised within a signal that is signaled from an encoder.

According to an embodiment, the signal is comprised in a Supplemental Enhancement Information (SEI) message or in an Adaptation Parameter Set (APS).

According to an embodiment, a signal comprising information relating to the one or more controlling values is generated.

According to an embodiment, the computer program product is embodied on a non-transitory computer readable medium.

### DESCRIPTION OF THE DRAWINGS

In the following, various embodiments will be described in more detail with reference to the appended drawings, in which

FIG. 1 shows an example of a codec with neural network (NN) components;

FIG. 2 shows another example of a video coding system with neural network components;

FIG. 3 shows an example of a neural network-based end-to-end learned codec;

FIG. 4 shows an example of a neural network-based end-to-end learned video coding system;

FIG. 5 shows an example of a video coding for machines;

FIG. 6 shows an example of a pipeline for end-to-end learned system for video coding for machines;

FIG. 7 shows an example of training an end-to-end learned codec;

FIG. 8 shows an implementation example according to a first embodiment;

FIG. 9 shows an implementation example according to a second embodiment;

FIG. 10 shows an implementation example according to a third embodiment;

FIG. 11 shows an implementation example according to a fourth embodiment;

FIG. 12 shows an implementation example according to a fifth embodiment;

FIG. 13 shows an implementation example according to a sixth embodiment;

FIG. 14 is a flowchart illustrating a method according to an embodiment;

FIG. 15 is a flowchart illustrating a method for decoding according to an embodiment;

FIG. 16 shows an apparatus according to an embodiment.

### DESCRIPTION OF EXAMPLE EMBODIMENTS

The following description and drawings are illustrative and are not to be construed as unnecessarily limiting. The specific details are provided for a thorough understanding of the disclosure. However, in certain instances, well-known or conventional details are not described in order to avoid obscuring the description. References to one or an embodiment in the present disclosure can be, but not necessarily are, reference to the same embodiment and such references mean at least one of the embodiments.

Reference in this specification to “one embodiment” or “an embodiment” means that a particular feature, structure, or characteristic described in connection with the embodiment is included in at least one embodiment of the disclosure.

Before discussing the present embodiments in more detailed manner, a short reference to related technology is given.

In the context of machine learning, a neural network (NN) is a computation graph consisting of several layers of computation. Each layer consists of one or more units, where each unit performs an elementary computation. A unit is connected to one or more other units, and the connection may have associated with a weight. The weight may be used for scaling the signal passing through the associated connection. Weights are learnable parameters, i.e., values which can be learned from training data. There may be other learnable parameters, such as those of batch-normalization layers.

Two widely used architectures for neural networks are feed-forward and recurrent architectures. Feed-forward neural networks are such that there is no feedback loop: each layer takes input from one or more of the layers before and provides its output as the input for one or more of the subsequent layers. Also, units inside a certain layer take input from units in one or more of preceding layers and provide output to one or more of following layers.

Initial layers (those close to the input data) extract semantically low-level features such as edges and textures in images, and intermediate and final layers extract more high-level features. After the feature extraction layers there may be one or more layers performing a certain task, such as classification, semantic segmentation, object detection, denoising, style transfer, super-resolution, etc. In recurrent neural nets, there is a feedback loop, so that the network becomes stateful, i.e., it is able to memorize information or a state.

Neural networks are being utilized in an ever-increasing number of applications for many different types of devices, such as mobile phones. Examples include image and video analysis and processing, social media data analysis, device usage data analysis, etc.

One of the important properties of neural networks (and other machine learning tools) is that they are able to learn properties from input data, either in supervised way or in unsupervised way. Such learning is a result of a training algorithm, or of a meta-level neural network providing the training signal.

In general, the training algorithm consists of changing some properties of the neural network so that its output is as close as possible to a desired output. For example, in the case of classification of objects in images, the output of the neural network can be used to derive a class or category index which indicates the class or category that the object in the input image belongs to. Training usually happens by minimizing or decreasing the output's error, also referred to as the loss. Examples of losses are mean squared error, cross-entropy, etc. In recent deep learning techniques, training is an iterative process, where at each iteration the algorithm modifies the weights of the neural net to make a gradual improvement of the network's output, i.e., to gradually decrease the loss.

In this description, terms “model” and “neural network” are used interchangeably, and also the weights of neural networks are sometimes referred to as learnable parameters or simply as parameters.

Training a neural network is an optimization process. The goal of the optimization or training process is to make the model learn the properties of the data distribution from a limited training dataset. In other words, the goal is to learn to use a limited training dataset in order to learn to generalize to previously unseen data, i.e., data which was not used for training the model. This is usually referred to as generalization. In practice, data may be split into at least two sets, the training set and the validation set. The training set is used for training the network, i.e., to modify its learnable parameters in order to minimize the loss. The validation set is used for checking the performance of the network on data, which was not used to minimize the loss, as an indication of the final performance of the model. In particular, the errors on the training set and on the validation set are monitored during the training process to understand the following things:
If the network is learning at all—in this case, the training set error should decrease, otherwise the model is in the regime of underfitting.
If the network is learning to generalize—in this case, also the validation set error needs to decrease and to be not too much higher than the training set error. If the training set error is low, but the validation set error is much higher than the training set error, or it does not decrease, or it even increases, the model is in the regime of overfitting. This means that the model has just memorized the training set's properties and performs well only on that set but performs poorly on a set not used for tuning its parameters.

Lately, neural networks have been used for compressing and de-compressing data such as images, i.e., in an image codec. The most widely used architecture for realizing one component of an image codec is the auto-encoder, which is a neural network consisting of two parts: a neural encoder and a neural decoder. The neural encoder takes as input an image and produces a code which requires less bits than the input image. This code may be obtained by applying a binarization or quantization process to the output of the encoder. The neural decoder takes in this code and reconstructs the image which was input to the neural encoder.

Such neural encoder and neural decoder may be trained to minimize a combination of bitrate and distortion, where the distortion may be based on one or more of the following metrics: Mean Squared Error (MSE), Peak Signal-to-Noise Ratio (PSNR), Structural Similarity Index Measure (SSIM), or similar. These distortion metrics are meant to be correlated to the human visual perception quality, so that minimizing or maximizing one or more of these distortion metrics results into improving the visual quality of the decoded image as perceived by humans.

Video codec comprises an encoder that transforms the input video into a compressed representation suited for storage/transmission and a decoder that can decompress the compressed video representation back into a viewable form. An encoder may discard some information in the original video sequence in order to represent the video in a more compact form (that is, at lower bitrate).

The H.264/AVC standard was developed by the Joint Video Team (JVT) of the Video Coding Experts Group (VCEG) of the Telecommunications Standardization Sector of International Telecommunication Union (ITU-T) and the Moving Picture Experts Group (MPEG) of International Organisation for Standardization (ISO)/International Electrotechnical Commission (IEC). The H.264/AVC standard is published by both parent standardization organizations, and it is referred to as ITU-T Recommendation H.264 and ISO/IEC International Standard 14496-10, also known as MPEG-4 Part 10 Advanced Video Coding (AVC). Extensions of the H.264/AVC include Scalable Video Coding (SVC) and Multiview Video Coding (MVC).

The High Efficiency Video Coding (H.265/HEVC a.k.a. HEVC) standard was developed by the Joint Collaborative Team-Video Coding (JCT-VC) of VCEG and MPEG. The standard was published by both parent standardization organizations, and it is referred to as ITU-T Recommendation H.265 and ISO/IEC International Standard 23008-2, also known as MPEG-H Part 2 High Efficiency Video Coding (HEVC). Later versions of H.265/HEVC included scalable, multiview, fidelity range, three-dimensional, and screen content coding extensions which may be abbreviated SHVC, MV-HEVC, REXT, 3D-HEVC, and SCC, respectively.

Versatile Video Coding (H.266 a.k.a. VVC), defined in ITU-T Recommendation H.266 and equivalently in ISO/IEC 23090-3, (also referred to as MPEG-I Part 3) is a video compression standard developed as the successor to HEVC. A reference software for VVC is the VVC Test Model (VTM).

A specification of the AV1 bitstream format and decoding process were developed by the Alliance for Open Media (AOM). The AV1 specification was published in 2018. AOM is reportedly working on the AV2 specification.

An elementary unit for the input to a video encoder and the output of a video decoder, respectively, in most cases is a picture. A picture given as an input to an encoder may also be referred to as a source picture, and a picture decoded by a decoder may be referred to as a decoded picture or a reconstructed picture.

The source and decoded pictures are each comprises of one or more sample arrays, such as one of the following sets of sample arrays:
Luma (Y) only (monochrome),
Luma and two chroma (YCbCr or YCgCo),
Green, Blue and Red (GBR, also known as RGB),
Arrays representing other unspecified monochrome or tri-stimulus color samplings (for example, YZX, also known as XYZ).

A component may be defined as an array or single sample from one of the three sample arrays (luma and two chroma) that compose a picture, or the array or a single sample of the array that compose a picture in monochrome format.

Hybrid video codecs, for example ITU-T H.263 and H.264, may encode the video information in two phases. Firstly, pixel values in a certain picture area (or “block”) are predicted for example by motion compensation means (finding and indicating an area in one of the previously coded video frames that corresponds closely to the block being coded) or by spatial means (using the pixel values around the block to be coded in a specified manner). Secondly the prediction error, i.e., the difference between the predicted block of pixels and the original block of pixels, is coded. This may be done by transforming the difference in pixel values using a specified transform (e.g., Discrete Cosine Transform (DCT) or a variant of it), quantizing the coefficients and entropy coding the quantized coefficients. By varying the fidelity of the quantization process, encoder can control the balance between the accuracy of the pixel representation (picture quality) and size of the resulting coded video representation (file size or transmission bitrate).

Inter prediction, which may also be referred to as temporal prediction, motion compensation, or motion-compensated prediction, exploits temporal redundancy. In inter prediction the sources of prediction are previously decoded pictures.

Intra prediction utilizes the fact that adjacent pixels within the same picture are likely to be correlated. Intra prediction can be performed in spatial or transform domain, i.e., either sample values or transform coefficients can be predicted. Intra prediction is typically exploited in intra coding, where no inter prediction is applied.

One outcome of the coding procedure is a set of coding parameters, such as motion vectors and quantized transform coefficients. Many parameters can be entropy-coded more efficiently if they are predicted first from spatially or temporally neighboring parameters. For example, a motion vector may be predicted from spatially adjacent motion vectors and only the difference relative to the motion vector predictor may be coded. Prediction of coding parameters and intra prediction may be collectively referred to as in-picture prediction.

The decoder reconstructs the output video by applying prediction means similar to the encoder to form a predicted representation of the pixel blocks (using the motion or spatial information created by the encoder and stored in the compressed representation) and prediction error decoding (inverse operation of the prediction error coding recovering the quantized prediction error signal in spatial pixel domain). After applying prediction and prediction error decoding means, the decoder sums up the prediction and prediction error signals (pixel values) to form the output video frame. The decoder (and encoder) can also apply additional filtering means to improve the quality of the output video before passing it for display and/or storing it as prediction reference for the forthcoming frames in the video sequence.

In video codecs, the motion information may be indicated with motion vectors associated with each motion compensated image block. Each of these motion vectors represents the displacement of the image block in the picture to be coded (in the encoder side) or decoded (in the decoder side) and the prediction source block in one of the previously coded or decoded pictures. In order to represent motion vectors efficiently, those may be coded differentially with respect to block specific predicted motion vectors. In video codecs, the predicted motion vectors may be created in a predefined way, for example calculating the median of the encoded or decoded motion vectors of the adjacent blocks. Another way to create motion vector predictions is to generate a list of candidate predictions from adjacent blocks and/or co-located blocks in temporal reference pictures and signaling the chosen candidate as the motion vector predictor. In addition to predicting the motion vector values, the reference index of previously coded/decoded picture can be predicted. The reference index is typically predicted from adjacent blocks and/or or co-located blocks in temporal reference picture. Moreover, high efficiency video codecs can employ an additional motion information coding/decoding mechanism, often called merging/merge mode, where all the motion field information, which includes motion vector and corresponding reference picture index for each available reference picture list, is predicted and used without any modification/correction. Similarly, predicting the motion field information may be carried out using the motion field information of adjacent blocks and/or co-located blocks in temporal reference pictures and the used motion field information is signaled among a list of motion field candidate list filled with motion field information of available adjacent/co-located blocks.

In video codecs the prediction residual after motion compensation may be first transformed with a transform kernel (like DCT) and then coded. The reason for this is that often there still exists some correlation among the residual and transform can in many cases help reduce this correlation and provide more efficient coding.

Video encoders may utilize Lagrangian cost functions to find optimal coding modes, e.g., the desired coding mode for a block, block partitioning, and associated motion vectors. This kind of cost function uses a weighting factor λ to tie together the (exact or estimated) image distortion due to lossy coding methods and the (exact or estimated) amount of information that is required to represent the pixel values in an image area:

$$C = D + λ R $$

where C is the Lagrangian cost to be minimized, D is the image distortion (e.g., Mean Squared Error) with the mode and motion vectors considered, and R the number of bits needed to represent the required data to reconstruct the image block in the decoder (including the amount of data to represent the candidate motion vectors). The rate R may be the actual bitrate or bit count resulting from encoding. Alternatively, the rate R may be an estimated bitrate or bit count. One possible way of the estimating the rate R is to omit the final entropy encoding step and use e.g., a simpler entropy encoding or an entropy encoder where some of the context states have not been updated according to previously encoding mode selections.

Conventionally used distortion metrics may comprise, but are not limited to, peak signal-to-noise ratio (PSNR), mean squared error (MSE), sum of absolute differences (SAD), sub of absolute transformed differences (SATD), and structural similarity (SSIM), typically measured between the reconstructed video/image signal (that is or would be identical to the decoded video/image signal) and the “original” video/image signal provided as input for encoding.

A partitioning may be defined as a division of a set into subsets such that each element of the set is in exactly one of the subsets.

Some examples of block partitioning according to H.266/VVC and AV1 are provided in the following paragraphs. Similar concepts may apply in other video coding specifications too.

In VVC, the samples are processed in units of coding tree blocks (CTB). The array size for each luma CTB in both width and height is CtbSizeY in units of samples. An encoder may select CtbSizeY on a sequence basis from values supported in the VVC standard (32, 64, 128), or the encoder may be configured to use a certain CtbSizeY value. The width and height of the array for each chroma CTB are CtbWidthC and CtbHeightC, respectively, in units of samples.

Each CTB is assigned a partition signalling to identify the block sizes for intra or inter prediction and for transform coding. The partitioning is a recursive quadtree partitioning. The root of the quadtree is associated with the CTB. The quadtree is split until a leaf is reached, which is referred to as the quadtree leaf. When the component width is not an integer number of the CTB size, the CTBs at the right component boundary are incomplete. When the component height is not an integer multiple of the CTB size, the CTBs at the bottom component boundary are incomplete.

The coding block is the root node of two trees, the prediction tree and the transform tree. The prediction tree specifies the position and size of prediction blocks. The transform tree specifies the position and size of transform blocks. The splitting information for luma and chroma is identical for the prediction tree and may or may not be identical for the transform tree.

The blocks and associated syntax structures are grouped into “unit” structures as follows:
One transform block (monochrome picture) or three transform blocks (luma and chroma components of a picture in 4:2:0, 4:2:2 or 4:4:4 colour format) and the associated transform syntax structures units are associated with a transform unit.
One coding block (monochrome picture) or three coding blocks (luma and chroma), the associated coding syntax structures and the associated transform units are associated with a coding unit.
One CTB (monochrome picture) or three CTBs (luma and chroma), the associated coding tree syntax structures and the associated coding units are associated with a CTU.

A superblock in AV1 is similar to a CTU in VVC. A superblock may be regarded as the largest coding block that the AV1 specification supports. The size of the superblock is signalled in the sequence header to be 128×128 or 64×64 luma samples. A superblock may be partitioned into smaller coding blocks recursively. A coding block may have its own prediction and transform modes, independent of those of the other coding blocks.

A bitstream may be defined as a sequence of bits or a sequence of syntax structures. A bitstream format may constrain the order of syntax structures in the bitstream.

A syntax element may be defined as an element of data represented in the bitstream. A syntax structure may be defined as zero or more syntax elements present together in the bitstream in a specified order.

In some coding formats or standards, a bitstream may be in the form of a network abstraction layer (NAL) unit stream or a byte stream, that forms the representation of coded pictures and associated data forming one or more coded video sequences.

In some formats or standards, a first bitstream may be followed by a second bitstream in the same logical channel, such as in the same file or in the same connection of a communication protocol. An elementary stream (in the context of video coding) may be defined as a sequence of one or more bitstreams.

In some coding formats or standards, the end of a bitstream may be indicated by a specific NAL unit, which may be referred to as the end of bitstream (EOB) NAL unit and which is the last NAL unit of the bitstream.

An elementary unit for the output of encoders of some coding formats, such as H.264/AVC, HEVC, or VVC, and the input of decoders of some coding formats, such as H.264/AVC, HEVC, or VVC, is a Network Abstraction Layer (NAL) unit. For transport over packet-oriented networks or storage into structured files, NAL units may be encapsulated into packets or similar structures.

A NAL unit may be defined as a syntax structure containing an indication of the type of data to follow and bytes containing that data in the form of an RBSP interspersed as necessary with start code emulation prevention bytes. A raw byte sequence payload (RBSP) may be defined as a syntax structure containing an integer number of bytes that is encapsulated in a NAL unit. An RBSP is either empty or has the form of a string of data bits containing syntax elements followed by an RBSP stop bit and followed by zero or more subsequent bits equal to 0.

A NAL unit comprises a header and a payload. The NAL unit header may indicate the type of the NAL unit among other things.

In some coding formats, such as AV1, a bitstream may comprise a sequence of open bitstream units (OBUs). An OBU comprises a header and a payload, wherein the header identifies a type of the OBU. Furthermore, the header may comprise a size of the payload in bytes.

Each picture of a temporally scalable bitstream may be assigned with a temporal identifier, which may be, for example, assigned to a variable TemporalId. The temporal identifier may, for example, be indicated in a NAL unit header or in an OBU extension header. TemporalId equal to 0 corresponds to the lowest temporal level. The bitstream created by excluding all coded pictures having a TemporalId greater than or equal to a selected value and including all other coded pictures remains conforming. Consequently, a picture having TemporalId equal to tid_value does not use any picture having a TemporalId greater than tid_value as a prediction reference.

NAL units may be categorized into Video Coding Layer (VCL) NAL units and non-VCL NAL units. VCL NAL units may be coded slice NAL units.

Images can be split into independently codable and decodable image segments (e.g., slices or tiles or tile groups). Such image segments may enable parallel processing. Image segments may be coded as separate units in the bitstream, such as VCL NAL units in H.264/AVC, HEVC, and VVC. Coded image segments may comprise a header and a payload, wherein the header contains parameter values needed for decoding the payload.

In some video coding formats, such as HEVC and VVC, a picture is divided into one or more tile rows and one or more tile columns. A tile is a sequence of coding tree units (CTU) that covers a rectangular region of a picture. The partitioning to tiles forms a grid that may be characterized by a list of tile column widths (in CTUs) and a list of tile row heights (in CTUs). For encoding and/or decoding, the CTUs in a tile are scanned in raster scan order within that tile. In HEVC, tiles are ordered in the bitstream consecutively in the raster scan order of the tile grid.

In some video coding formats, such as AV1, a picture may be partitioned into tiles, and a tile consists of an integer number of complete superblocks that collectively form a complete rectangular region of a picture. In-picture prediction across tile boundaries is disabled. The minimum tile size is one superblock, and the maximum tile size in the presently specified levels in AV1 is 4096×2304 in terms of luma sample count. The picture is partitioned into a tile grid of one or more tile rows and one or more tile columns. The tile grid may be signaled in the picture header to have a uniform tile size or nonuniform tile size, where in the latter case the tile row heights and tile column widths are signaled. The superblocks in a tile are scanned in raster scan order within that tile.

In some video coding formats, such as VVC, a slice consists of an integer number of complete tiles or an integer number of consecutive complete CTU rows within a tile of a picture. Consequently, each vertical slice boundary is always also a vertical tile boundary. It is possible that a horizontal boundary of a slice is not a tile boundary but consists of horizontal CTU boundaries within a tile; this occurs when a tile is split into multiple rectangular slices, each of which consists of an integer number of consecutive complete CTU rows within the tile.

In some video coding formats, such as VVC, two modes of slices are supported, namely the raster-scan slice mode and the rectangular slice mode. In the raster-scan slice mode, a slice contains a sequence of complete tiles in a tile raster scan of a picture. In the rectangular slice mode, a slice contains either a number of complete tiles that collectively form a rectangular region of the picture or a number of consecutive complete CTU rows of one tile that collectively form a rectangular region of the picture. Tiles within a rectangular slice are scanned in tile raster scan order within the rectangular region corresponding to that slice.

In HEVC, a slice consists of an integer number of CTUs. The CTUs are scanned in the raster scan order of CTUs within tiles or within a picture, if tiles are not in use. A slice may contain an integer number of tiles, or a slice can be contained in a tile. Within a CTU, the CUs have a specific scan order.

In HEVC, a slice is defined to be an integer number of coding tree units contained in one independent slice segment and all subsequent dependent slice segments (if any) that precede the next independent slice segment (if any) within the same access unit. In HEVC, a slice segment is defined to be an integer number of coding tree units ordered consecutively in the tile scan and contained in a single NAL (Network Abstraction Layer) unit. The division of each picture into slice segments is a partitioning. In HEVC, an independent slice segment is defined to be a slice segment for which the values of the syntax elements of the slice segment header are not inferred from the values for a preceding slice segment, and a dependent slice segment is defined to be a slice segment for which the values of some syntax elements of the slice segment header are inferred from the values for the preceding independent slice segment in decoding order. In HEVC, a slice header is defined to be the slice segment header of the independent slice segment that is a current slice segment or is the independent slice segment that precedes a current dependent slice segment, and a slice segment header is defined to be a part of a coded slice segment containing the data elements pertaining to the first or all coding tree units represented in the slice segment. The CUs are scanned in the raster scan order of LCUs within tiles or within a picture, if tiles are not in use. Within an LCU, the CUs have a specific scan order.

In some video coding formats, such as AV1, a tile group OBU carries one or more complete tiles. The first and last tiles of in the tile group OBU may be indicated in the tile group OBU before the coded tile data. Tiles within a tile group OBU may appear in a tile raster scan of a picture.

A non-VCL NAL unit may be for example one of the following types: a sequence parameter set, a picture parameter set, a supplemental enhancement information (SEI) NAL unit, an access unit delimiter, an end of sequence NAL unit, an end of bitstream NAL unit, or a filler data NAL unit. Parameter sets may be needed for the reconstruction of decoded pictures, whereas many of the other non-VCL NAL units are not necessary for the reconstruction of decoded sample values.

Some coding formats specify parameter sets that may carry parameter values needed for the decoding or reconstruction of decoded pictures. A parameter may be defined as a syntax element of a parameter set. A parameter set may be defined as a syntax structure that contains parameters and that can be referred to from or activated by another syntax structure for example using an identifier.

A coding standard or specification may specify several types of parameter sets. It needs to be understood that embodiments may be applied but are not limited to the described types of parameter sets and embodiments could likewise be applied to any parameter set type.

A parameter set may be activated when it is referenced e.g., through its identifier. An adaptation parameter set (APS) may be defined as a syntax structure that applies to zero or more slices. There may be different types of adaptation parameter sets. An adaptation parameter set may for example contain filtering parameters for a particular type of a filter. In VVC, three types of APSs are specified carrying parameters for one of: adaptive loop filter (ALF), luma mapping with chroma scaling (LMCS), and scaling lists. A scaling list may be defined as a list that associates each frequency index with a scale factor for the scaling process, which multiplies transform coefficient levels by a scaling factor, resulting in transform coefficients. In VVC, an APS is referenced through its type (e.g., ALF, LMCS, or scaling list) and an identifier. In other words, different types of APSs have their own identifier value ranges.

An Adaptation Parameter Set (APS) may comprise parameters for decoding processes of different types, such as adaptive loop filtering or luma mapping with chroma scaling. Instead of or in addition to parameter sets at different hierarchy levels (e.g., sequence and picture), video coding formats may include header syntax structures, such as a sequence header or a picture header.

A sequence header may precede any other data of the coded video sequence in the bitstream order. It may be allowed to repeat a sequence header in the bitstream, e.g., to provide a sequence header at a random access point.

A picture header may precede any coded video data for the picture in the bitstream order. A picture header may be interchangeably referred to as a frame header. Some video coding specifications may enable carriage of a picture header in a dedicated picture header NAL unit or a frame header OBU or alike. Some video coding specifications may enable carriage of a picture header in a NAL unit, OBU, or alike syntax structure that also contains coded picture data.

Video coding specifications may enable the use of supplemental enhancement information (SEI) messages, metadata syntax structures, or alike. An SEI message, a metadata syntax structure, or alike may not be required for the decoding of output pictures but may assist in related process(es), such as picture output timing, post-processing of decoded pictures, rendering, error detection, error concealment, and resource reservation.

Some video coding specifications include SEI network abstraction layer (NAL) units, and some video coding specifications contain both prefix SEI NAL units and suffix SEI NAL units, where the former type can start a picture unit or alike and the latter type can end a picture unit or alike. An SEI NAL unit contains one or more SEI messages, which are not required for the decoding of output pictures but may assist in related processes, such as picture output timing, post-processing of decoded pictures, rendering, error detection, error concealment, and resource reservation. Several SEI messages are specified in H.264/AVC, H.265/HEVC, H.266/VVC, and H.274/VSEI standards, and the user data SEI messages enable organizations and companies to specify SEI messages for their own use. The standards may contain the syntax and semantics for the specified SEI messages but a process for handling the messages in the recipient might not be defined. Consequently, encoders may be required to follow the standard specifying a SEI message when they create SEI message(s), and decoders might not be required to process SEI messages for output order conformance. One of the reasons to include the syntax and semantics of SEI messages in standards is to allow different system specifications to interpret the supplemental information identically and hence interoperate. It is intended that system specifications can require the use of particular SEI messages both in the encoding end and in the decoding end, and additionally the process for handling particular SEI messages in the recipient can be specified. SEI messages are generally not extended in future amendments or versions of the standard.

Some video coding specifications enable metadata OBUs. A metadata OBU comprises a type field, which specifies the type of metadata.

The phrase along the bitstream (e.g., indicating along the bitstream) or along a coded unit of a bitstream (e.g., indicating along a coded tile) may be used in claims and described embodiments to refer to transmission, signaling, or storage in a manner that the “out-of-band” data is associated with but not included within the bitstream or the coded unit, respectively. The phrase decoding along the bitstream or along a coded unit of a bitstream or alike may refer to decoding the referred out-of-band data (which may be obtained from out-of-band transmission, signaling, or storage) that is associated with the bitstream or the coded unit, respectively. For example, the phrase along the bitstream may be used when the bitstream is contained in a container file, such as a file conforming to the ISO Base Media File Format, and certain file metadata is stored in the file in a manner that associates the metadata to the bitstream, such as boxes in the sample entry for a track containing the bitstream, a sample group for the track containing the bitstream, or a timed metadata track associated with the track containing the bitstream.

Image and video codecs may use a set of filters to enhance the visual quality of the predicted visual content and can be applied either in-loop or out-of-loop, or both. In the case of in-loop filters, the filter applied on one block in the currently-encoded frame will affect the encoding of another block in the same frame and/or in another frame which is predicted from the current frame. An in-loop filter can affect the bitrate and/or the visual quality. In fact, an enhanced block will cause a smaller residual (difference between original block and predicted-and-filtered block), thus requiring less bits to be encoded. An out-of-the loop filter will be applied on a frame after it has been reconstructed, the filtered visual content won't be as a source for prediction, and thus it may only impact the visual quality of the frames that are output by the decoder.

Recently, neural network (NNs) have been used in the context of image and video compression by following mainly two approaches.

In one approach, NNs are used to replace one or more of the components of a traditional codec such as VVC/H.266. Here, term “traditional” refers to those codecs whose components and their parameters may not be learned from data. Examples of such components are:
Additional in-loop filter, for example by having the NN as an additional in-loop filter with respect to the traditional loop filters.
Single in-loop filter, for example by having the NN replacing all traditional in-loop filters.
Intra-frame prediction.
Inter-frame prediction.
Transform and/or inverse transform.
Probability model for the arithmetic codec.
Etc.

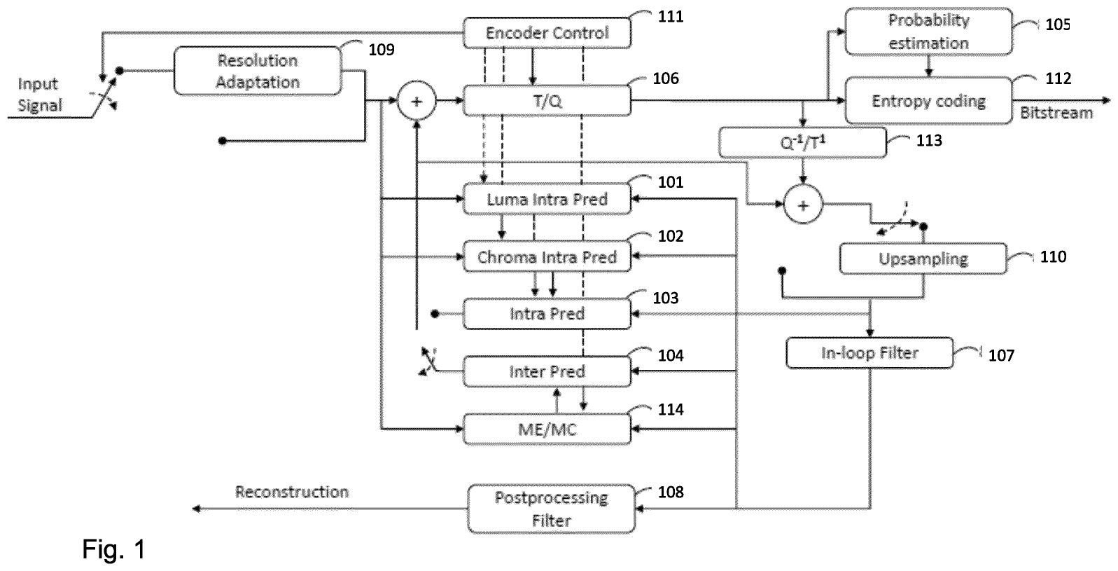

FIG. 1 illustrates examples of functioning of NNs as components of a traditional codec's pipeline, in accordance with an embodiment. In particular, FIG. 1 illustrates an encoder, which also includes a decoding loop. FIG. 1 is shown to include components described below:
A luma intra pred block or circuit 101. This block or circuit performs intra prediction in the luma domain, for example, by using already reconstructed data from the same frame. The operation of the luma intra pred block or circuit 101 may be performed by a deep neural network such as a convolutional auto-encoder.
A chroma intra pred block or circuit 102. This block or circuit performs intra prediction in the chroma domain, for example, by using already reconstructed data from the same frame. The chroma intra pred block or circuit 102 may perform cross-component prediction, for example, predicting chroma from luma. The operation of the chroma intra pred block or circuit 102 may be performed by a deep neural network such as a convolutional auto-encoder.
An intra pred block or circuit 103 and inter-pred block or circuit 104. These blocks or circuit perform intra prediction and inter-prediction, respectively. The intra pred block or circuit 103 and the inter-pred block or circuit 104 may perform the prediction on all components, for example, luma and chroma. The operations of the intra pred block or circuit 103 and inter-pred block or circuit 104 may be performed by two or more deep neural networks such as convolutional auto-encoders.
A probability estimation block or circuit 105 for entropy coding. This block or circuit performs prediction of probability for the next symbol to encode or decode, which is then provided to the entropy coding module 112, such as the arithmetic coding module, to encode or decode the next symbol. The operation of the probability estimation block or circuit 105 may be performed by a neural network.
A transform and quantization (T/Q) block or circuit 106. These are actually two blocks or circuits. The transform and quantization block or circuit 106 may perform a transform of input data to a different domain, for example, the FFT transform would transform the data to frequency domain. The transform and quantization block or circuit 106 may quantize its input values to a smaller set of possible values. In the decoding loop, there may be inverse quantization block or circuit and inverse transform block or circuit 113. One or both of the transform block or circuit and quantization block or circuit may be replaced by one or two or more neural networks. One or both of the inverse transform block or circuit and inverse quantization block or circuit 113 may be replaced by one or two or more neural networks.
An in-loop filter block or circuit 107. Operations of the in-loop filter block or circuit 107 is performed in the decoding loop, and it performs filtering on the output of the inverse transform block or circuit, or anyway on the reconstructed data, in order to enhance the reconstructed data with respect to one or more predetermined quality metrics. This filter may affect both the quality of the decoded data and the bitrate of the bitstream output by the encoder. The operation of the in-loop filter block or circuit 107 may be performed by a neural network, such as a convolutional auto-encoder. In examples, the operation of the in-loop filter may be performed by multiple steps or filters, where the one or more steps may be performed by neural networks.
A postprocessing filter block or circuit 108. The postprocessing filter block or circuit 108 may be performed only at decoder side, as it may not affect the encoding process. The postprocessing filter block or circuit 108 filters the reconstructed data output by the in-loop filter block or circuit 107, in order to enhance the reconstructed data. The postprocessing filter block or circuit 108 may be replaced by a neural network, such as a convolutional auto-encoder.
A resolution adaptation block or circuit 109: this block or circuit may downsample the input video frames, prior to encoding. Then, in the decoding loop, the reconstructed data may be upsampled, by the upsampling block or circuit 110, to the original resolution. The operation of the resolution adaptation block or circuit 109 block or circuit may be performed by a neural network such as a convolutional auto-encoder.
An encoder control block or circuit 111. This block or circuit performs optimization of encoder's parameters, such as what transform to use, what quantization parameters (QP) to use, what intra-prediction mode (out of N intra-prediction modes) to use, and the like. The operation of the encoder control block or circuit 111 may be performed by a neural network, such as a classifier convolutional network, or such as a regression convolutional network.
An ME/MC block or circuit 114 performs motion estimation and/or motion compensation, which are two key operations to be performed when performing inter-frame prediction. ME/MC stands for motion estimation/motion compensation.

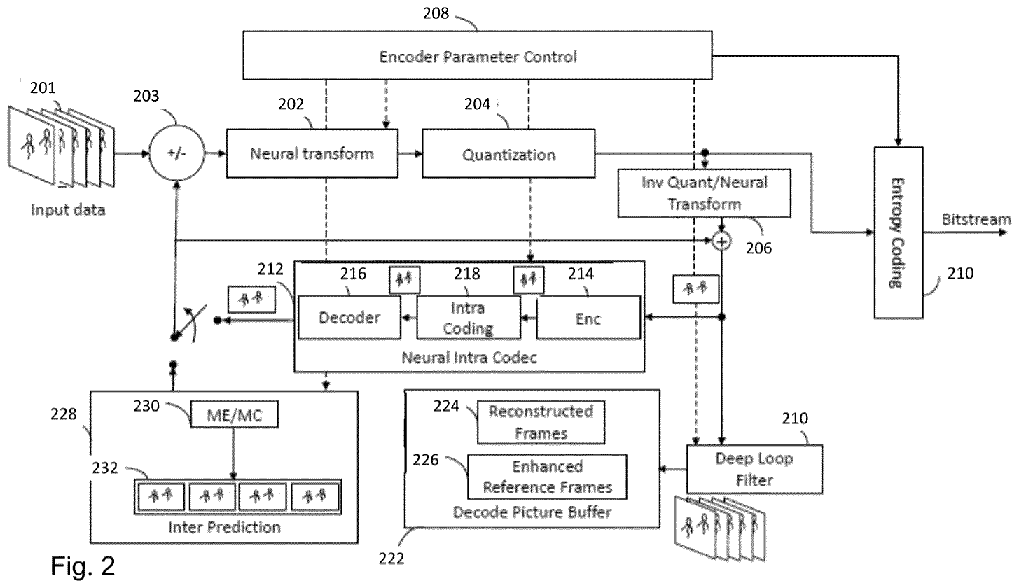

In another approach, commonly referred to as “end-to-end learned compression”, NNs are used as the main components of the image/video codecs. In this second approach, there are two main options:
Option 1: re-use the video coding pipeline but replace most or all the components with NNs. Referring to FIG. 2, it illustrates an example of modified video coding pipeline based on a neural network, in accordance with an embodiment. An example of neural network may include, but is not limited to, a compressed representation of a neural network. FIG. 2 is shown to include following components:
   A neural transform block or circuit 202: this block or circuit transforms the output of a summation/subtraction operation 203 to a new representation of that data, which may have lower entropy and thus be more compressible.
   A quantization block or circuit 204: this block or circuit quantizes an input data 201 to a smaller set of possible values.
   An inverse transform and inverse quantization blocks or circuits 206. These blocks or circuits perform the inverse or approximately inverse operation of the transform and the quantization, respectively.
   An encoder parameter control block or circuit 208. This block or circuit may control and optimize some or all the parameters of the encoding process, such as parameters of one or more of the encoding blocks or circuits.
   An entropy coding block or circuit 210. This block or circuit may perform lossless coding, for example based on entropy. One popular entropy coding technique is arithmetic coding.
   A neural intra-codec block or circuit 212. This block or circuit may be an image compression and decompression block or circuit, which may be used to encode and decode an intra frame. An encoder 214 may be an encoder block or circuit, such as the neural encoder part of an auto-encoder neural network. A decoder 216 may be a decoder block or circuit, such as the neural decoder part of an auto-encoder neural network. An intra-coding block or circuit 218 may be a block or circuit performing some intermediate steps between encoder and decoder, such as quantization, entropy encoding, entropy decoding, and/or inverse quantization.
   A deep loop filter block or circuit 220. This block or circuit performs filtering of reconstructed data, in order to enhance it.
   A decode picture buffer block or circuit 222. This block or circuit is a memory buffer, keeping the decoded frame, for example, reconstructed frames 224 and enhanced reference frames 226 to be used for inter prediction.
   An inter-prediction block or circuit 228. This block or circuit performs inter-frame prediction, for example, predicts from frames, for example, frames 232, which are temporally nearby. An ME/MC 230 performs motion estimation and/or motion compensation, which are two key operations to be performed when performing inter-frame prediction. ME/MC stands for motion estimation/motion compensation.
Option 2: re-design the whole pipeline, as follows.
   Encoder NN is configured to perform a non-linear transform;
   Quantization and lossless encoding of the encoder NN's output;
   Lossless decoding and dequantization;
   Decoder NN is configured to perform a non-linear inverse transform.

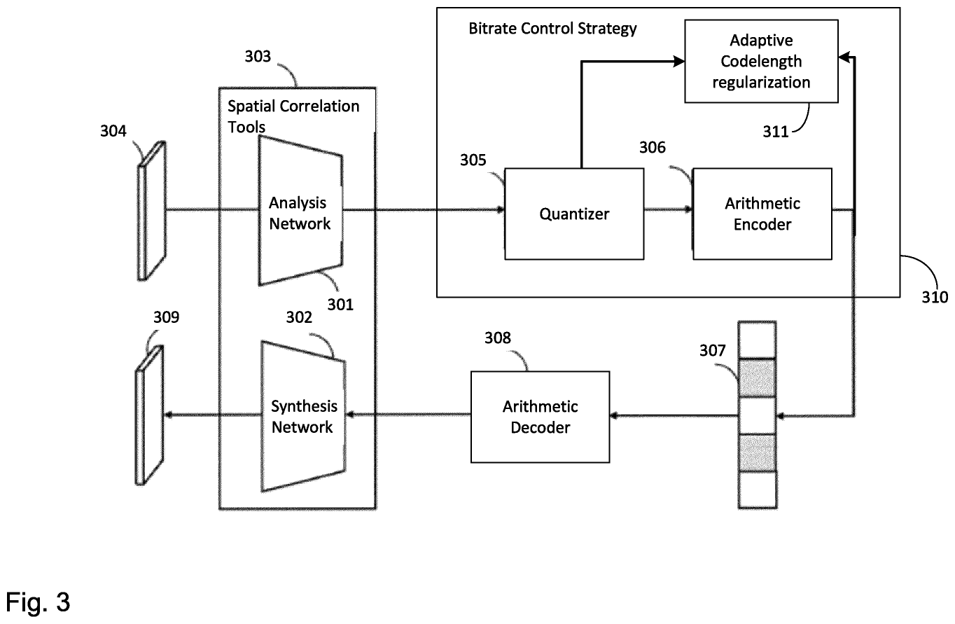

An example of option 2 is described in detail in FIG. 3 which shows an encoder NN and a decoder NN being parts of a neural auto-encoder architecture, in accordance with an example. In FIG. 3, the Analysis Network 301 is an Encoder NN, and the Synthesis Network 302 is the Decoder NN, which may together be referred to as spatial correlation tools 303, or as neural auto-encoder.

As shown in FIG. 3, the input data 304 is analyzed by the Encoder NN (Analysis Network 301), which outputs a new representation of that input data. The new representation may be more compressible. This new representation may then be quantized, by a quantizer 305, to a discrete number of values. The quantized data is then lossless encoded, for example by an arithmetic encoder 306, thus obtaining a bitstream 307. The example shown in FIG. 3 includes an arithmetic decoder 308 and an arithmetic encoder 306. The arithmetic encoder 306, or the arithmetic decoder 308, or the combination of the arithmetic encoder 306 and arithmetic decoder 308 may be referred to as arithmetic codec in some embodiments. On the decoding side, the bitstream is first lossless decoded, for example, by using the arithmetic codec decoder 308. The lossless decoded data is dequantized and then input to the Decoder NN, Synthesis Network 302. The output is the reconstructed or decoded data 309.

In case of lossy compression, the lossy steps may comprise the Encoder NN and/or the quantization.

In order to train this system, a training objective function (also called “training loss”) may be utilized, which may comprise one or more terms, or loss terms, or simply losses. In one example, the training loss comprises a reconstruction loss term and a rate loss term. The reconstruction loss encourages the system to decode data that is similar to the input data, according to some similarity metric. Examples of reconstruction losses are:
Mean squared error (MSE);
Multi-scale structural similarity (MS-SSIM);
Losses derived from the use of a pretrained neural network. For example, error(f1, f2), where f1 and f2 are the features extracted by a pretrained neural network for the input data and the decoded data, respectively, and error( ) is an error or distance function, such as L1 norm or L2 norm;
Losses derived from the use of a neural network that is trained simultaneously with the end-to-end learned codec. For example, adversarial loss can be used, which is the loss provided by a discriminator neural network that is trained adversarially with respect to the codec, following the settings proposed in the context of Generative Adversarial Networks (GANs) and their variants.

The rate loss encourages the system to compress the output of the encoding stage, such as the output of the arithmetic encoder. By “compressing”, we mean reducing the number of bits output by the encoding stage.

When an entropy-based lossless encoder is used, such as an arithmetic encoder, the rate loss typically encourages the output of the Encoder NN to have low entropy. Example of rate losses are the following:
A differentiable estimate of the entropy;
A sparsification loss, i.e., a loss that encourages the output of the Encoder NN or the output of the quantization to have many zeros. Examples are L0 norm, L1 norm, L1 norm divided by L2 norm;
A cross-entropy loss applied to the output of a probability model, where the probability model may be a NN used to estimate the probability of the next symbol to be encoded by an arithmetic encoder.

One or more of reconstruction losses may be used, and one or more of the rate losses may be used, as a weighted sum. The different loss terms may be weighted using different weights, and these weights determine how the final system performs in terms of rate-distortion loss. For example, if more weight is given to the reconstruction losses with respect to the rate losses, the system may learn to compress less but to reconstruct with higher accuracy (as measured by a metric that correlates with the reconstruction losses). These weights may be considered to be hyper-parameters of the training session and may be set manually by the person designing the training session, or automatically for example by grid search or by using additional neural networks.

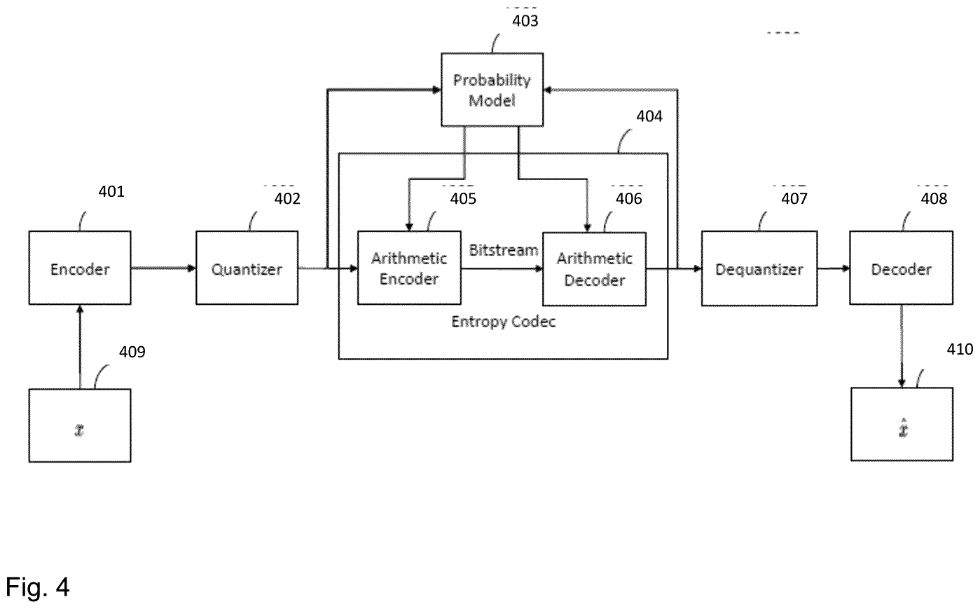

As shown in FIG. 4, a neural network-based end-to-end learned video coding system may contain an encoder 401, a quantizer 402, a probability model 403, an entropy codec 420 (for example arithmetic encoder 405/arithmetic decoder 406), a dequantizer 407, and a decoder 408. The encoder 401 and decoder 408 may be two neural networks, or mainly comprise neural network components. The probability model 403 may also comprise mainly neural network components. Quantizer 402, dequantizer 407 and entropy codec 420 may not be based on neural network components, but they may also comprise neural network components, potentially.

On the encoder side, the encoder component 401 takes a video x 409 as input and converts the video from its original signal space into a latent representation that may comprise a more compressible representation of the input. In the case of an input image, the latent representation may be a 3-dimensional tensor, where two dimensions represent the vertical and horizontal spatial dimensions, and the third dimension represent the “channels” which contain information at that specific location. If the input image is a 128×128×3 RGB image (with horizontal size of 128 pixels, vertical size of 128 pixels, and 3 channels for the Red, Green, Blue color components), and if the encoder downsamples the input tensor by 2 and expands the channel dimension to 32 channels, then the latent representation is a tensor of dimensions (or “shape”) 64×64×32 (i.e., with horizontal size of 64 elements, vertical size of 64 elements, and 32 channels). Please note that the order of the different dimensions may differ depending on the convention which is used; in some cases, for the input image, the channel dimension may be the first dimension, so for the above example, the shape of the input tensor may be represented as 3×128×128, instead of 128×128×3. In the case of an input video (instead of just an input image), another dimension in the input tensor may be used to represent temporal information.

The quantizer component 402 quantizes the latent representation into discrete values given a predefined set of quantization levels. Probability model 403 and arithmetic codec component 420 work together to perform lossless compression for the quantized latent representation and generate bitstreams to be sent to the decoder side. Given a symbol to be encoded into the bitstream, the probability model 403 estimates the probability distribution of all possible values for that symbol based on a context that is constructed from available information at the current encoding/decoding state, such as the data that has already been encoded/decoded. Then, the arithmetic encoder 405 encodes the input symbols to bitstream using the estimated probability distributions.

On the decoder side, opposite operations are performed. The arithmetic decoder 406 and the probability model 403 first decode symbols from the bitstream to recover the quantized latent representation. Then the dequantizer 407 reconstructs the latent representation in continuous values and pass it to decoder 408 to recover the input video/image. Note that the probability model 403 in this system is shared between the encoding and decoding systems. In practice, this means that a copy of the probability model 403 is used at encoder side, and another exact copy is used at decoder side.

In this system, the encoder 401, probability model 403, and decoder 408 may be based on deep neural networks. The system may be trained in an end-to-end manner by minimizing the following rate-distortion loss function:

$$L = D + λ R ,$$

where D is the distortion loss term, R is the rate loss term, and A is the weight that controls the balance between the two losses. The distortion loss term may be the mean square error (MSE), structure similarity (SSIM) or other metrics that evaluate the quality of the reconstructed video. Multiple distortion losses may be used and integrated into D, such as a weighted sum of MSE and SSIM. The rate loss term is normally the estimated entropy of the quantized latent representation, which indicates the number of bits necessary to represent the encoded symbols, for example, bits-per-pixel (bpp).

For lossless video/image compression, the system may contain only the probability model 403 and arithmetic encoder/decoder 405, 406. The system loss function contains only the rate loss, since the distortion loss is always zero (i.e., no loss of information).

Reducing the distortion in image and video compression is often intended to increase human perceptual quality, as humans are considered to be the end users, i.e., consuming/watching the decoded image. Recently, with the advent of machine learning, especially deep learning, there is a rising number of machines (i.e., autonomous agents) that analyze data independently from humans and that may even take decisions based on the analysis results without human intervention. Examples of such analysis are object detection, scene classification, semantic segmentation, video event detection, anomaly detection, pedestrian tracking, etc. Example use cases and applications are self-driving cars, video surveillance cameras and public safety, smart sensor networks, smart TV and smart advertisement, person re-identification, smart traffic monitoring, drones, etc. When the decoded data is consumed by machines, a different quality metric shall be used instead of human perceptual quality. Also, dedicated algorithms for compressing and decompressing data for machine consumption are likely to be different than those for compressing and decompressing data for human consumption. The set of tools and concepts for compressing and decompressing data for machine consumption is referred to here as Video Coding for Machines (VCM).

VCM concerns the encoding of video streams to allow consumption for machines. Machine is referred to indicate any device except human. Example of machine can be a mobile phone, an autonomous vehicle, a robot, and such intelligent devices which may have a degree of autonomy or run an intelligent algorithm to process the decoded stream beyond reconstructing the original input stream.

A machine may perform one or multiple tasks on the decoded stream. Examples of tasks can comprise the following:
Classification: classify an image or video into one or more predefined categories. The output of a classification task may be a set of detected categories, also known as classes or labels. The output may also include the probability and confidence of each predefined category.
Object detection: detect one or more objects in a given image or video. The output of an object detection task may be the bounding boxes and the associated classes of the detected objects. The output may also include the probability and confidence of each detected object.
Instance segmentation: identify one or more objects in an image or video at the pixel level. The output of an instance segmentation task may be binary mask images or other representations of the binary mask images, e.g., closed contours, of the detected objects. The output may also include the probability and confidence of each object for each pixel.
Semantic segmentation: assign the pixels in an image or video to one or more predefined semantic categories. The output of a semantic segmentation task may be binary mask images or other representations of the binary mask images, e.g., closed contours, of the assigned categories. The output may also include the probability and confidence of each semantic category for each pixel.
Object tracking: track one or more objects in a video sequence. The output of an object tracking task may include frame index, object ID, object bounding boxes, probability, and confidence for each tracked object.
Captioning: generate one or more short text descriptions for an input image or video. The output of the captioning task may be one or more short text sequences.
Human pose estimation: estimate the position of the key points, e.g., wrist, elbows, knees, etc., from one or more human bodies in an image of the video. The output of a human pose estimation includes sets of locations of each key point of a human body detected in the input image or video.
Human action recognition: recognize the actions, e.g., walking, talking, shaking hands, of one or more people in an input image or video. The output of the human action recognition may be a set of predefined actions, probability, and confidence of each identified action.
Anomaly detection: detect abnormal object or event from an input image or video. The output of an anomaly detection may include the locations of detected abnormal objects or segments of frames where abnormal events detected in the input video.

It is likely that the receiver-side device has multiple “machines” or task neural networks (Task-NNs). These multiple machines may be used in a certain combination which is for example determined by an orchestrator sub-system. The multiple machines may be used for example in succession, based on the output of the previously used machine, and/or in parallel. For example, a video which was compressed and then decompressed may be analyzed by one machine (NN) for detecting pedestrians, by another machine (another NN) for detecting cars, and by another machine (another NN) for estimating the depth of all the pixels in the frames.

In this description, “task machine” and “machine” and “task neural network” are referred to interchangeably, and for such referral any process or algorithm (learned or not from data) which analyzes or processes data for a certain task is meant. In the rest of the description, other assumptions made regarding the machines considered in this disclosure may be specified in further details. Also, term “receiver-side” or “decoder-side” are used to refer to the physical or abstract entity or device, which contains one or more machines, and runs these one or more machines on an encoded and eventually decoded video representation which is encoded by another physical or abstract entity or device, the “encoder-side device”.

The encoded video data may be stored into a memory device, for example as a file. The stored file may later be provided to another device. Alternatively, the encoded video data may be streamed from one device to another.

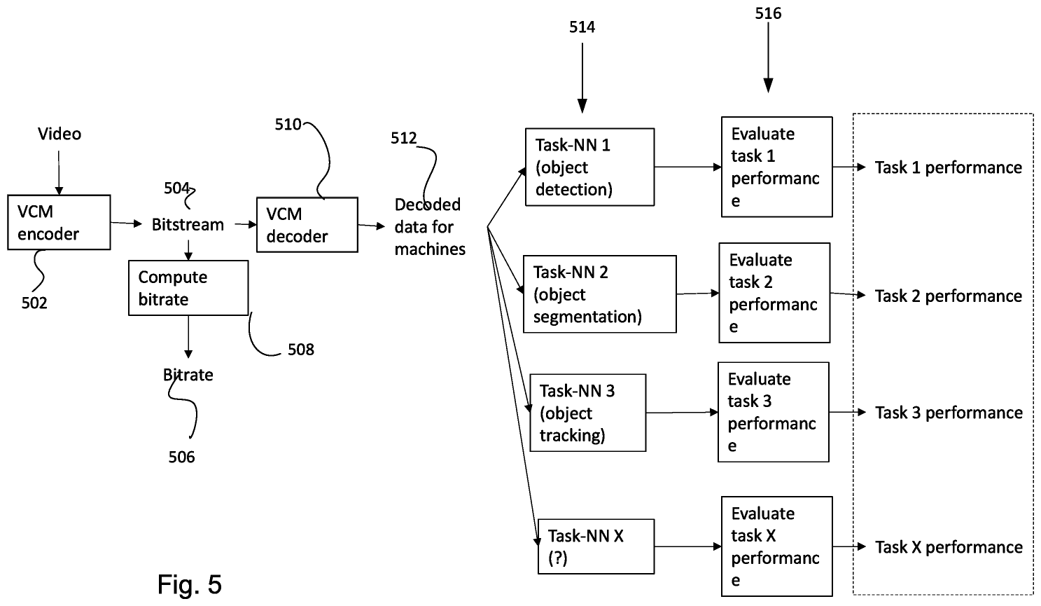

FIG. 5 is a general illustration of the pipeline of Video Coding for Machines. A VCM encoder 502 encodes the input video into a bitstream 504. A bitrate 506 may be computed 508 from the bitstream 504 in order to evaluate the size of the bitstream. A VCM decoder 510 decodes the bitstream output by the VCM encoder 502. In FIG. 5, the output of the VCM decoder 510 is referred to as “Decoded data for machines” 512. This data may be considered as the decoded or reconstructed video. However, in some implementations of this pipeline, this data may not have same or similar characteristics as the original video which was input to the VCM encoder 502. For example, this data may not be easily understandable by a human when rendering the data onto a screen. The output of VCM decoder is then input to one or more task neural networks 514. In the figure, for the sake of illustrating that there may be any number of task-NNs 514, there are three example task-NNs, and a non-specified one (Task-NN X). The goal of VCM is to obtain a low bitrate representation of the input video while guaranteeing that the task-NNs still perform well in terms of the evaluation metric 516 associated to each task.

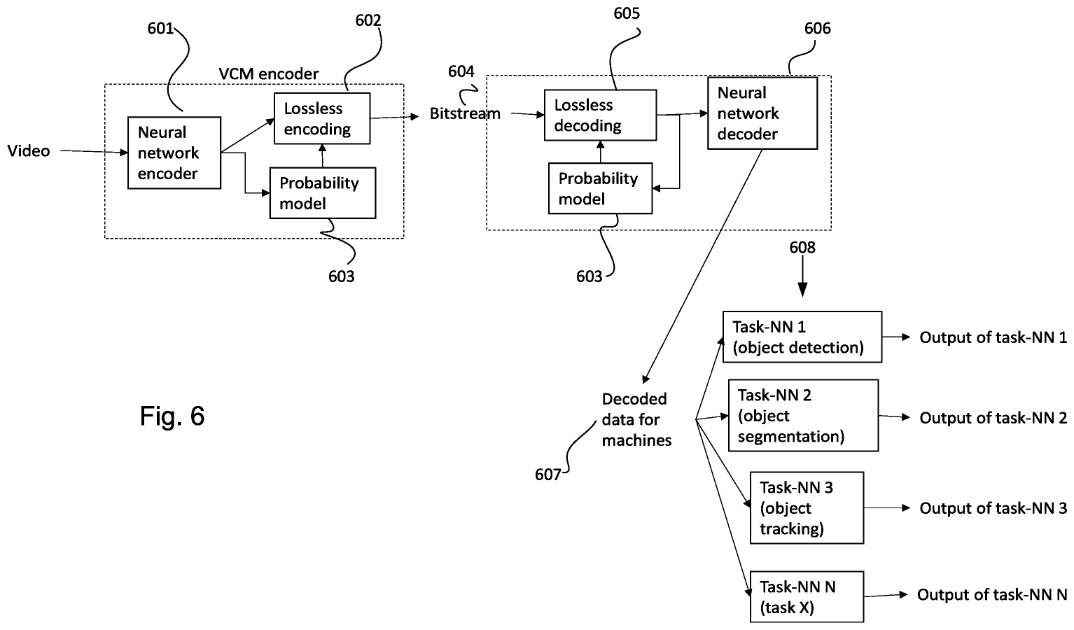

One of the possible approaches to realize video coding for machines is an end-to-end learned approach. In this approach, the VCM encoder and VCM decoder mainly consist of neural networks. FIG. 6 illustrates an example of a pipeline for the end-to-end learned approach. The video is input to a neural network encoder 601. The output of the neural network encoder 601 is input to a lossless encoder 602, such as an arithmetic encoder, which outputs a bitstream 604. The output of the neural network encoder 601 may be input also to a probability model 603 which provides to the lossless encoder 602 with an estimate of the probability of the next symbol to be encoded by the lossless encoder 602. The probability model 603 may be learned by means of machine learning techniques, for example it may be a neural network. At decoder-side, the bitstream 604 is input to a lossless decoder 605, such as an arithmetic decoder, whose output is input to a neural network decoder 606. The output of the lossless decoder 605 may be input to a probability model 603, which provides the lossless decoder 605 with an estimate of the probability of the next symbol to be decoded by the lossless decoder 605. The output of the neural network decoder 606 is the decoded data for machines 607, that may be input to one or more task-NNs 608.

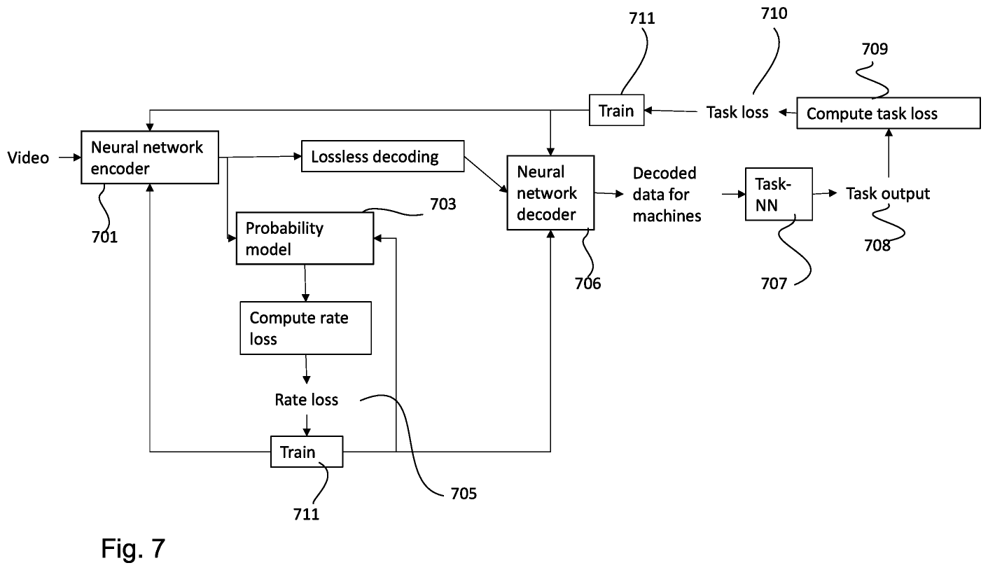

FIG. 7 illustrates an example of how the end-to-end learned system may be trained for the purpose of video coding for machines. For the sake of simplicity, only one task-NN 707 is illustrated. A rate loss 705 may be computed from the output of the probability model 703. The rate loss 705 provides an approximation of the bitrate required to encode the input video data. A task loss 710 may be computed 709 from the output 708 of the task-NN 707.

The rate loss 705 and the task loss 710 may then be used to train 711 the neural networks used in the system, such as the neural network encoder 701, the probability model 703, the neural network decoder 706. Training may be performed by first computing gradients of each loss with respect to the trainable neural networks' parameters that are contributing or affecting the computation of that loss. The gradients are then used by an optimization method, such as Adam, for updating the trainable parameters of the neural networks.

The machine tasks may be performed at decoder side (instead of at encoder side) for multiple reasons, for example because the encoder-side device does not have the capabilities (computational, power, memory) for running the neural networks that perform these tasks, or because some aspects or the performance of the task neural networks may have changed or improved by the time that the decoder-side device needs the tasks results (e.g., different or additional semantic classes, better neural network architecture). Also, there could be a customization need, where different clients would run different neural networks for performing these machine learning tasks.

In some video codecs, a neural network may be used as a filter in the decoding loop, and it may be referred to as neural network loop filter, or neural network in-loop filter. The NN loop filter may replace one or more of the loop filters present in an existing video codec or may represent an additional loop filter with respect to the already present loop filters in an existing video codec. In the context of image and video enhancement, a neural network may be used as post-processing filter, for example applied to the output of an image or video decoder in order to remove or reduce coding artifacts.

A post-processing filter is taken as an example of a use case, where the task of the filter is to enhance the quality of an input video frame that has been decoded by a video decoder. The input data provided to a filter may include the frame to be filtered, and some additional data related to that frame or to the encoding or decoding process.

At least some of the present embodiments relate to neural networks used as part of the decoding operations (such as a NN loop filter, or an intra-frame prediction NN, or an inter-frame prediction NN) or as a part of post-processing operations (a NN post-processing filter). Also, at least some of the present embodiments relate to the signalling of information related to those NNs, where the information is signaled from an encoder to a decoder.

The following example system may be used in several embodiments to illustrate or describe the idea. The example system comprises a VVC/H.266 compliant codec and a post-processing NN (NN post-filter), where the NN post-filter is applied on at least an output of the decoder in order to enhance the quality of an output of the decoder (e.g., a decoded frame). Quality may be measured in terms of a metric that can include one or more of the following:
Mean-squared error (MSE);
Peak signal-to-noise ratio (PSNR);
Mean Average Precision (mAP) computed based at least on the output of a task NN (such as an object detection NN) when the input is the output of the post-processing NN;
Other task-related metrics, for tasks such as object tracking, video activity classification, video anomaly detection, etc.

The enhancement may result into a coding gain, which can be expressed for example in terms of BD-rate or BD-PSNR.

Prior to the present embodiments, it was common to provide, as input to a NN filter, additional data than just the decoded frame to be filtered. This additional data is referred to as “auxiliary data”. There may be different types of auxiliary data. The following are examples of data of auxiliary data types, or data from which auxiliary data are derived:
Quantization Parameter (QP), e.g., a sequence-level QP, or slice-level QP, or both;
Partitioning information, such as block partitioning;
Prediction data, e.g., the output of an intra-frame prediction process, or the output of an inter-frame prediction process;
Slice type (e.g., one of the following: I, P, or B);
Information about the temporal layer in a temporal prediction hierarchy;
Output of one or more filters, such as the output of SAO filter, or the output of a deblocking filter;
One or more variables derived for operation of one or more filters in the encoder and/or decoder, such as boundary strength data for a deblocking filter;
Data derived from previously decoded media units, such as data derived from one or more reference frames of a predicted frame, or data derived from an intra-coded frame.

The term “auxiliary data” and the term “auxiliary data types” may be used interchangeably in this document, and the meaning should be clear to a person skilled in the art based on the context.

The term “auxiliary features” may be used in this document to refer to features extracted from auxiliary data, for example based on one or more neural network layers.

At least some of the auxiliary data may be obtained from a decoder.

The motivation for why data of those auxiliary data types is input to a NN filter is that they may provide some useful information to the NN. For example, they may be used by the NN to improve a filtering process.

However, for some frames or blocks (such as CTUs), data of some of the auxiliary data types that are available may not improve the performance of the filter significantly or may even worsen its performance. Furthermore, for some frames or blocks, data of some auxiliary data types may be more useful/important than others. The current designs of NN filters do not comprise an explicit mechanism for automatically determining the contribution of a certain auxiliary data (or auxiliary data type). In addition, the current designs of NN filters do not comprise a mechanism for automatically determining the contribution of a certain auxiliary data (or auxiliary data type) adaptively with respect to the input data of the NN filter.

The present solution relates to various embodiments of an encoder configured to signal information indicative of which auxiliary data (e.g., which auxiliary data types) are used as auxiliary inputs or auxiliary features for the NN filter.

In one embodiment, the encoder may signal one or more flags to the decoder, where each one of the one or more flags is associated to one or more auxiliary data types or to one or more auxiliary data units.

In another embodiment, the encoder may signal one or more modulating values to the decoder, where each of the one or more modulating values is associated to one or more auxiliary data types or to one or more auxiliary data units.

In yet another embodiment, one or more layers of the NN filter may determine one or more modulating values, based at least on the decoded frame that is to be filtered by the NN filter, where each of the one or more modulating values is associated to one or more auxiliary data types or to one or more auxiliary data units.

These and other embodiments are discussed in more detailed manner in the following. Before going into details of the various embodiments, a short introduction of codecs is carried out.

A codec may be used for compressing and decompressing data in at least some of the embodiments being discussed. For the sake of simplicity, in at least some of the embodiments, video is an example of a data type. However, the proposed embodiments can be extended or directly applied to other types of data such as images, audio, etc.

When the data is video, an encoder-side device performs a compression or encoding operation of an input video by using a video encoder. The output of the video encoder is a bitstream representing the compressed video. When the data is audio, an encoder-side device performs a compression or encoding operation of an input audio by using an audio encoder. The output of the audio encoder is a bitstream representing the compressed audio.

For video data, a decoder-side device performs decompression or decoding operation of the compressed video by using a video decoder. The output of the video decoder may be referred to as “decoded video”. A frame which is comprised in a decoded video may be referred to as decoded frame. The decoded video may be post-processed by one or more post-processing operations, such as a post-processing filter. The filter may be applied to the whole decoded video, or to one or more decoded frames, or to one or more portions of one or more decoded frames. In one example, the filter is applied frame-wise, i.e., there is no dependence between the filtering of a first decoded frame and the filtering of a second decoded frame. The output of the one or more post-processing operations may be referred to as “post-processed video” or as post-processed frames.

On the other hand, for an audio data, a decoder-side device performs decompression or decoding operation of the compressed audio by using an audio decoder. The output of the audio decoder may be referred to as “decoded audio”. The decoded audio may be post-processed by one or more post-processing operations, such as a post-processing filter. The output of the one or more post-processing operations may be referred to as “post-processed audio”.

The encoder-side device may also comprise at least some decoding operations, for example in a coding loop, and/or at least some post-processing operations. In one example, the encoder may include all the decoding operations and any post-processing operations that are supported by and/or compliant to a certain coding standard.

The encoder-side device and the decoder-side device may be the same physical device, or different physical devices.

The decoder or the decoder-side device may contain one or more neural networks. Some examples of such neural networks are the following:
A post-processing NN filter (also referred to here as post-filter, or NN-post-filter, or post-filter NN), which takes as input at least one of the outputs of an end-to-end learned decoder or of a conventional decoder (i.e., a decoder not comprising neural networks or other components learned form data) or of a hybrid decoder (i.e., a decoder comprising one or more neural networks or other components learned from data).
A NN in-loop filter (also referred to here as in-loop NN filter, or NN loop filter, or loop NN filter), used within an end-to-end learned decoder, or within a hybrid decoder.
A learned probability model (e.g., a NN) that is used for providing estimates of probabilities of symbols to be encoded and/or decoded by a lossless coding module, within an end-to-end learned codec or within a hybrid codec.
A decoder neural network, part of an end-to-end learned codec.

### Embodiment 1: Signaling Flags

According to an embodiment, referred to as embodiment 1, the encoder may determine which of the auxiliary data available to the NN filter at decoder side shall be used as auxiliary inputs or auxiliary features for the NN filter at encoder side.

The determination may be based on rate-distortion optimization, or on distortion-only optimization, or on rate-only optimization. In one example, a brute-force approach is performed, where data of all the possible subsets of auxiliary data types are considered and the subset that is optimal is determined. In one example, one of the subsets comprises the whole set of auxiliary data types. In another example, each of the subsets comprises a single type of auxiliary data. In yet another example, at least one of the subsets comprises two or more types of auxiliary data.

In an embodiment, the encoder may signal an indication that an optimal subset of auxiliary data types is signaled to the decoder. For example, the indication may comprise a flag or binary variable. The flag and the binary variable represent one type of controlling values for the auxiliary features. It is appreciated that in some embodiment the controlling values are used for controlling the auxiliary data units. When the encoder signals that no optimal subset is signaled, the optimal subset may be predetermined and known at decoder side, or may be otherwise determined at the decoder side. This signaling may be at one or more granularity levels; for example, for every CTU, for every frame, for every Random Access segment, etc.

Based on the determined optimal subset, the encoder may signal information indicative of which auxiliary data shall be used as auxiliary inputs or auxiliary feature for the NN filter. This signaling may be at one or more granularity levels; for example, for every CTU, for every frame, for every Random Access segment, etc. In one example, the encoder signals information indicative of the auxiliary data types comprised in the determined optimal subset. In another example, the encoder signals information indicative of some of the auxiliary data types comprised in the determined optimal subset. In an embodiment, the signaled information may comprise one or more flags, where each of the one or more flags is associated to one auxiliary data type. For example, a first flag is associated to partitioning data, a second flag is associated to the QP information, etc.

Each of the one or more flags may be a binary variable.

According to an embodiment, the signaled information may comprise a set of identifiers, also referred to as gating values, each indicating an auxiliary data type that is used as auxiliary data or auxiliary feature for the NN filter. The identifier values may be pre-defined, for example, in a coding standard.

According to an embodiment, the signaled information may comprise a set of identifiers, each indicating an auxiliary data type that is not used as auxiliary data or auxiliary feature for the NN filter. The identifiers represent one type of controlling values for the auxiliary features. The identifier values may be pre-defined, for example in a coding standard. The encoder and/or the decoder determines the auxiliary data types to be all auxiliary data types supported by the NN filter excluding the auxiliary data types signaled by the set of identifiers.

According to an embodiment, the signaled information may comprise an identifier of an optimal subset out. At decoder side, the identifier is used to retrieve, for example from a look-up table, the respective predefined subset. That is, the decoder may have available a certain number of predefined subsets, and the encoder signals to the decoder which of those predefined subsets is the optimal one for filtering one or more portions of one or more frames.

The information indicative of which auxiliary data types are used as auxiliary inputs or auxiliary features for the NN filter may be signaled in or along the bitstream. In one example, the information is comprised in a Supplemental Enhancement Information (SEI) message. In another example, the information is comprised in an Adaptation Parameter Set (APS).

The signaled information may be encoded using a lossy and/or lossless encoder.

In an embodiment, the type of auxiliary data or auxiliary features for each filtering unit (e.g., CTU) may be inferred from one or more previously (de)coded filtering units in current frame and/or reference frame. For example, if no information, indicative of which auxiliary data types are used as auxiliary data or auxiliary features, is signaled for a certain CTU, then the decoder may determine the information for that CTU from either a pre-defined set of auxiliary data types (for example defined in the coding standard) or inherit such information from one or more of the (de)coded CTUs in the current frame and/or reference frame(s). In another example, a flag may be signaled in the bitstream that indicates to the decoder to infer the type of auxiliary data or auxiliary features for each filtering unit from the previously (de)coded filtering units.

In an embodiment, the information indicative of which auxiliary data types are used as auxiliary inputs or auxiliary features for the NN filter may be determined at decoder side based on one or more criteria and/or one or more data units. In one example, the one or more data units may comprise the input to the NN filter, that needs to be filtered.

At decoder side, the received signalling information indicative of which auxiliary data types are used as auxiliary data or auxiliary features for the NN filter, may be decoded or may be simply parsed. The decoded information is used to determine which auxiliary data types are used as auxiliary data or auxiliary features for the NN filter. According to an embodiment, one or more flags are decoded, where each of the one or more flags is associated to one auxiliary data type, and the decoded one or more flags are used to determine whether the auxiliary data types associated to the one or more flags are used as auxiliary data or auxiliary features for the NN filter. For example, if the value of a flag associated to the partitioning data is 0, the features extracted based at least on the partitioning data are not used in at least some operations of the NN filter.

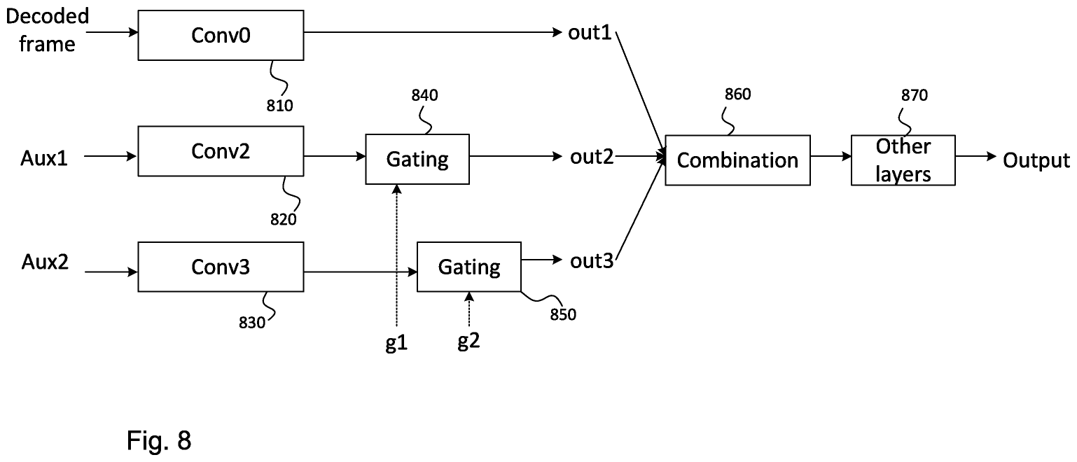

FIG. 8 illustrates an example of an NN filter, where there are three inputs:
a decoded frame, which needs to be filtered or enhanced by the NN filter. The decoded frame comprises one or more data units;
Aux1: data of a first type of auxiliary data, for example partitioning data. The data of the first type of auxiliary data is in the form of data units;
Aux2: data of a second type of auxiliary data, for example prediction data. The data of the second type of auxiliary data is in the form of data units;

The NN filter comprises three initial convolutional layers 810, 820, 830, which represent portions of a neural network:
Conv0 810: a convolutional layer, i.e., a first portion of the NN filter, that processes the decoded frame, and outputs a signal out1;
Conv2 820: a convolutional layer, i.e., a second portion of the NN filter, that processes Aux1, outputting features extracted from Aux1;
Conv3 830: a convolutional layer, i.e., another second portion of the NN filter, that processed Aux2, outputting features extracted from Aux2;

It is appreciated that the blocks 810, 820, 830 may comprise any number and type of neural network layers and other operations.

The features output by convolutional layers 820, 830 are gated 840, 850 based at least on the binary flags g1 and g2, respectively. The gating operations 840, 850, when the flag is 1, may cause their input signal to be output, whereas when the flag is 0, may cause no output, or the output to be a tensor of zeros or other predefined value. The output of the gating operation 840, 850 for features extracted by convolutional layers 820, 830 are out2 and out3, respectively. The gating is used for controlling the use of the features extracted by any of the second portions of the NN based processor, such as a filter.

The combination block 860 may combine its three inputs out1, out2, out3 into a signal. Thus, the signal comprises one or more sets of combined features. For example, the Combination block 860 may be a concatenation operation or a summation operation. Other layers 870, i.e., further portions of the NN based processor, represent a set of other NN layers in the NN filter, that are configured to process the combined outputs.

It is to be understood that the gating may be performed at a different point than after the feature extraction as shown in FIG. 8. In one example, the gating may be performed at the input, i.e., the Aux1 data and Aux2 data may be gated before extracting auxiliary features, thus the feature extraction represented by Conv2 and Conv3 may be skipped.

### Embodiment 2: Signaling Modulating Values

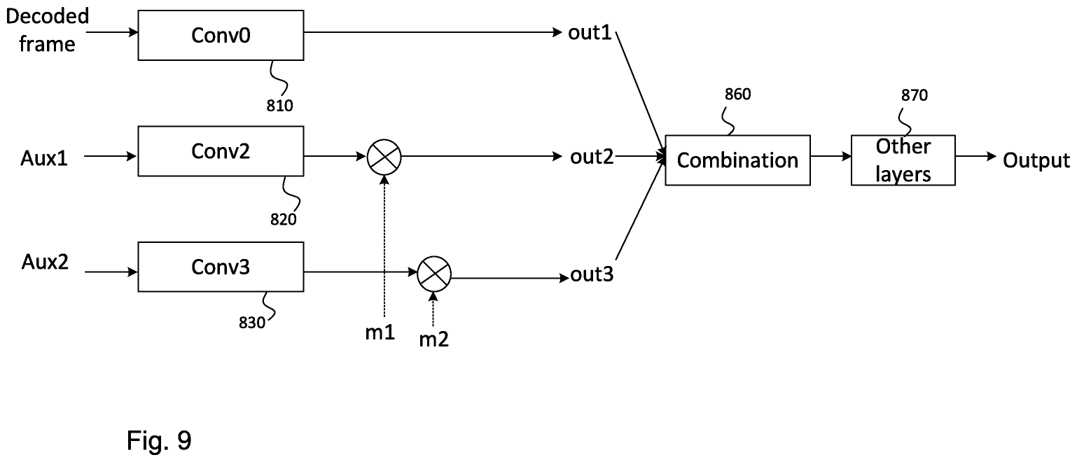

FIG. 9 illustrates an example implementation of a second embodiment, where the encoder may determine how to modulate the auxiliary data available to the NN filter at decoder side, or features extracted from those auxiliary data. The modulation is performed based at least on a modulation operation and on one or more modulating values. The modulation operation may be an element-wise multiplication. The encoder may determine the one or more modulating values, which represent one type of controlling values for the auxiliary features. It is appreciated that in some embodiment the controlling values are used for controlling the auxiliary data units.

The determination may be based on rate-distortion optimization, or on distortion-only optimization or on rate-only optimization. In one example, the determination is based on least-squares estimation. In another example, the determination is based on backpropagation and gradient descent.

The encoder may signal a flag indicative of whether the encoder signals information indicative of modulating values associated to auxiliary data types. If the flag is set to 0, the decoder may use a set of predefined modulating values, or may use no modulating values at all, for example according to a coding standard. This flag may be signaled at one or more granularity levels, such as for one or more portions of one or more frames.

The encoder may signal information indicative of the determined modulating values associated to auxiliary data types to the decoder.

According to an embodiment, the encoder may signal the determined one or more modulating values to the decoder, where each of the one or more modulating values is associated to one auxiliary data type. For example, a first modulating value is associated to partitioning data, a second modulating value is associated to the QP information, etc.

According to an embodiment, the encoder may signal one or more pairs where each pair may comprise an auxiliary data type and a respective modulating value to the decoder. The auxiliary data types that are not signaled to the decoder may have a pre-defined modulating value, for example predefined in a coding standard.

According to an embodiment, the encoder may signal an identifier of a set of modulating values. At decoder side, the identifier may be used for retrieving, for example via a look-up table, a respective set of modulating values. That is, the decoder may have available a certain number of predefined sets of modulating values, and the encoder signals to the decoder an identifier of the predefined set of modulating values to be used for modulating one or more auxiliary data.

According to an embodiment, the modulating values for each filtering unit (e.g., CTU) may be inferred from the previously (de)coded filtering units in current frame and/or reference frame. For example, if there are no modulating values signaled for a certain CTU, then the decoder may determine the modulating information for that CTU from either a pre-defined set of values (for example, defined in the coding standard) or derive such information from one or more (de)coded CTUs in the current frame and/or reference frame(s). In another example, a flag may be signaled in the bitstream that indicates to the decoder to infer the modulating values from the previously (de)coded filtering units.

Each of the one or more modulating values can be a Real value, or an Integer value, or a matrix of Real or Integer values, or a tensor of Real or Integer values.

The numerical value(s) of the modulating value may have been quantized/discretized by the encoder. For example, first a Real value is determined for each of the one or more modulating values, then the Real value may be quantized.

The one or more modulating values are used to modulate the associated auxiliary data, or data derived from the associated auxiliary data. In one example, the auxiliary data may be input to one or more NN layers, and the modulation is applied to an output of the one or more NN layers, for example to features extracted from the auxiliary data.

The one or more flags may be signaled in or along the bitstream. According to an example, the flags can be comprised in a Supplemental Enhancement Information (SEI) message. According to another example, the flags can be comprised in an Adaptation Parameter Set (APS).

The encoder may signal the modulating values directly, e.g., by entropy coding the modulating value, or may signal an indication of a modulating value. In an example of the latter case, a modulating value may take one out of three possible values {0, 0.5, 0.7} which are associated to three respective indicative values {0, 1, 2}. Thus, in order to indicate a value equal to 0.7, the encoder may signal the value 2. Upon receiving the indicative value 2, the decoder may use a look-up table to retrieve the corresponding value 0.7 and use it to modulate the auxiliary data or features derived from the auxiliary data associated to that modulating value.

FIG. 9 illustrates an example of an NN filter, where there are three inputs:
a decoded frame, which needs to be filtered or enhanced by the NN filter. The decoded frame comprises one or more data units;
Aux1: data of a first type of auxiliary data, for example partitioning data. The data of the first type of auxiliary data is in the form of data units;
Aux2: data of a second type of auxiliary data, for example prediction data. The data of the second type of auxiliary data is in the form of data units;

The NN filter comprises three initial convolutional layers 810, 820, 830, which represent portions of a neural network:
Conv0 810: a convolutional layer, i.e., a first portion of the NN filter, that processes the decoded frame, and outputs a signal out1;
Conv2 820: a convolutional layer, i.e., a second portion of the NN filter, that processes Aux1, outputting features extracted from Aux1;
Conv3 830: a convolutional layer, i.e., another second portion of the NN filter, that processed Aux2, outputting features extracted from Aux2;

It is appreciated that the blocks 810, 820, 830 may comprise any number and type of neural network layers and other operations.

In FIG. 9 two modulating values m1 and m2 are used to modulate the features extracted from Aux1 and Aux2. The modulation operation is an element-wise multiplication. The modulating values m1 and m2 may be two scalar numbers or may be two matrices where the matrix m1 multiplies all the matrices representing the feature tensor output by Conv2, or may be two 3-dimensional tensors. The modulating values are thus used for controlling the features extracted from Conv2 and Conv3, i.e., by modulating the associated auxiliary features derived based at least on the associated auxiliary data.

The combination block 860 may combine its three inputs out1, out2, out3 into a signal. Thus, the signal comprises one or more sets of combined features. For example, the Combination block 860 may be a concatenation operation or a summation operation. Other layers 870, i.e., further portions of the NN based processor, represent a set of other NN layers in the NN filter, that are configured to process the combined outputs.

### Embodiment 3: Self-Modulation

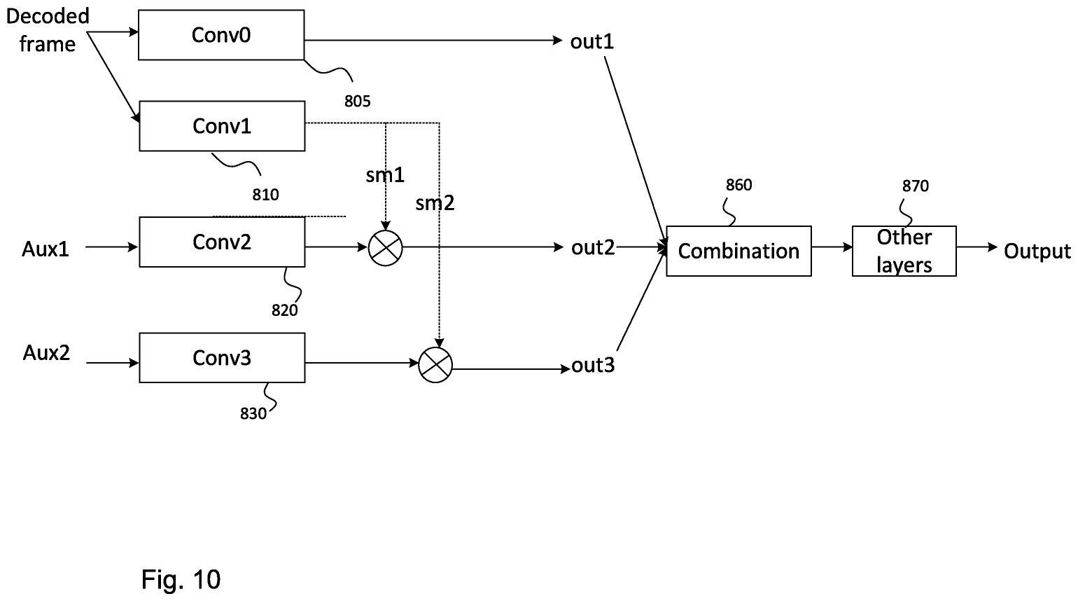

FIG. 10 illustrates an example implementation of a third embodiment, where one or more layers of the NN filter may determine one or more modulating values, based at least on the decoded frame that is filtered by the NN filter.

Additionally, the one or more layers may take as input one or more auxiliary data.

Each of the one or more modulating values is associated to one or more auxiliary data types. For example, a first modulating value is associated to partitioning data, a second modulating value is associated to the QP information, etc. These modulating values represent one type of controlling values for the auxiliary features. It is appreciated that in some embodiment the controlling values are used for controlling the auxiliary data units.

Each of the one or more modulating values can be a Real value, or an Integer value, or a matrix of Real of Integer values, or a tensor of Real or Integer values. In one example, a modulating value is a tensor with same shape as the data that it modulates.

The one or more modulating values is used to modulate the associated auxiliary data, or data derived from the associated auxiliary data. In one example, the auxiliary data may be input to one or more NN layers, and the modulation is applied to an output of the one or more NN layers.

Thus, FIG. 10 illustrates an example of an NN filter, where there are three inputs:
a decoded frame, which needs to be filtered or enhanced by the NN filter. The decoded frame comprises one or more data units;
Aux1: data of a first type of auxiliary data, for example partitioning data. The data of the first type of auxiliary data is in the form of data units;
Aux2: data of a second type of auxiliary data, for example prediction data. The data of the second type of auxiliary data is in the form of data units;

The NN filter comprises four initial convolutional layers 805, 810, 820, 830, which represent portions of a neural network:
Conv0 805: a convolutional layer, i.e., a first portion of the NN filter, that processes the decoded frame, and outputs a signal out1;
Conv0 810: a convolutional layer, i.e., another first portion of the NN filter, that processes the decoded frame, and outputs modulating values sm1, sm2;
Conv2 820: a convolutional layer, i.e., a second portion of the NN filter, that processes Aux1, outputting features extracted from Aux1;
Conv3 830: a convolutional layer, i.e., another second portion of the NN filter, that processed Aux2, outputting features extracted from Aux2;

It is appreciated that the blocks 805, 810, 820, 830 may comprise any number and type of neural network layers and other operations.

In FIG. 10, the modulating value sm1 and sm2 modulate the features derived from Aux1 and Aux2 based on the convolutional layers Conv2 and Conv3, respectively. The modulation operation is an element-wise multiplication. The modulating values sm1 and sm2 are output by one or more NN layers, for example by a convolutional layer Conv1 based at least on the decoded frame.

The modulating values are thus used for controlling the features extracted from Conv2 and Conv3, i.e., by modulating the associated auxiliary features derived based at least on the associated auxiliary data.

The combination block 860 may combine its three inputs out1, out2, out3 into a signal. Thus, the signal comprises one or more sets of combined features. For example, the Combination block 860 may be a concatenation operation or a summation operation.

Other layers 870, i.e., further portions of the NN based processor, represent a set of other NN layers in the NN filter, that are configured to process the combined outputs.

### Embodiment 4: Combining Self-Modulation and Signaled Gating Flags

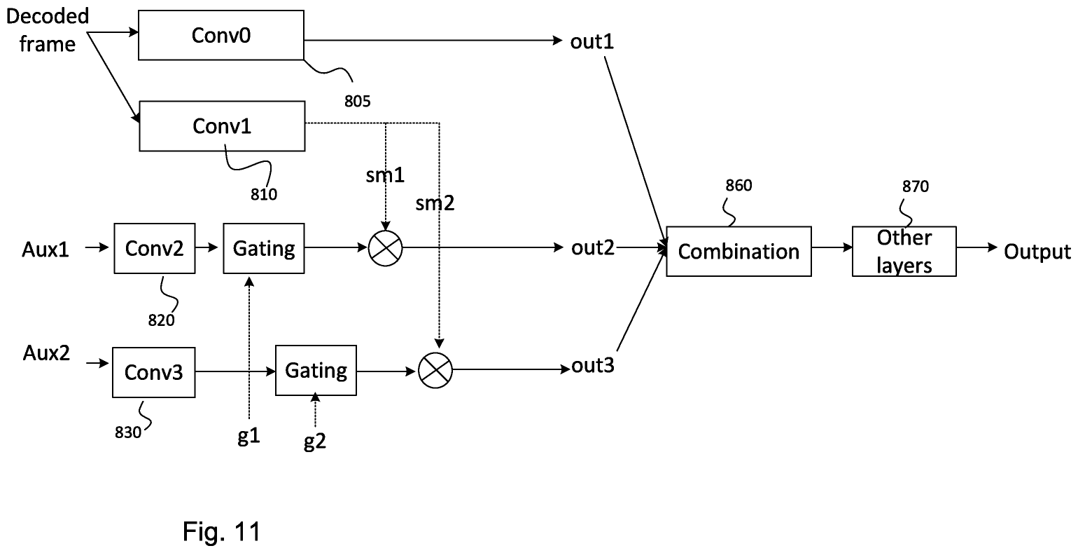

FIG. 11 illustrates an example implementation of the fourth embodiment, which is a combination of embodiment 1 and embodiment 3. The encoder may signal information indicative of one or more gating flags. Self-modulation may be performed by the NN filter.

The encoder may further signal to the decoder an indication of whether to perform the gating, for example by signalling a binary flag referred to as enable_gating_flag. If this binary flag is set to 1, the encoder also signals the one or more gating flags, which are used by the decoder for performing the gating.

The encoder may signal to the decoder an indication of whether to perform the self-modulation, for example, by signalling a binary flag referred to as enable_self_modulation_flag. If this binary flag is set to 1, the decoder applies self-modulation.

The gating and the modulating values are thus used for controlling the features extracted from Conv2 and Conv3, and thus they represent controlling values for the auxiliary features. It is appreciated that in some embodiment the controlling values are used for controlling the auxiliary data units.

The combination block 860 may combine its three inputs out1, out2, out3 into a signal. Thus, the signal comprises one or more sets of combined features. For example, the Combination block 860 may be a concatenation operation or a summation operation. Other layers 870, i.e., further portions of the NN based processor, represent a set of other NN layers in the NN filter, that are configured to process the combined outputs.

### Embodiment 5: Combining Self-Modulation and Signaled Modulating Values

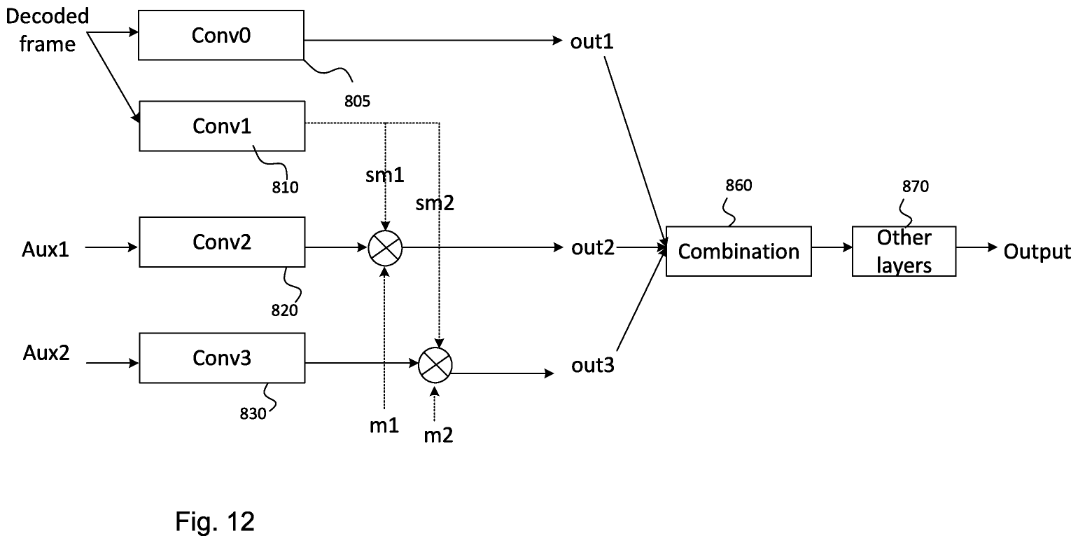

FIG. 12 illustrates an example implementation of the fifth embodiment, which is a combination of embodiment 2 and embodiment 3. The encoder may signal information indicative of one or more modulating values. Self-modulation may be performed by the NN filter.

The encoder may signal to the decoder an indication of whether to perform the modulation by using one or more modulating values signaled by the encoder, for example by signaling a binary flag referred to as enable_encoder_modulation_flag. If this binary flag is set to 1, the encoder further signals the one or more modulating values, which are used by the decoder for performing the modulating operations.

The encoder may signal to the decoder an indication of whether to perform the self-modulation, for example, by signaling a binary flag referred to as enable_self_modulation_flag. If this binary flag is set to 1, the decoder applies self-modulation.

The self-modulating values and the modulating values are used for controlling the features extracted from Conv2 and Conv3, and thus they represent controlling values for the auxiliary features. It is appreciated that in some embodiment the controlling values are used for controlling the auxiliary data units.

The combination block 860 may combine its three inputs out1, out2, out3 into a signal. Thus, the signal comprises one or more sets of combined features. For example, the Combination block 860 may be a concatenation operation or a summation operation. Other layers 870, i.e., further portions of the NN based processor, represent a set of other NN layers in the NN filter, that are configured to process the combined outputs.

### Embodiment 6: Combining Self-Modulation and Signaled Gating Flags and Signaled Modulating Values

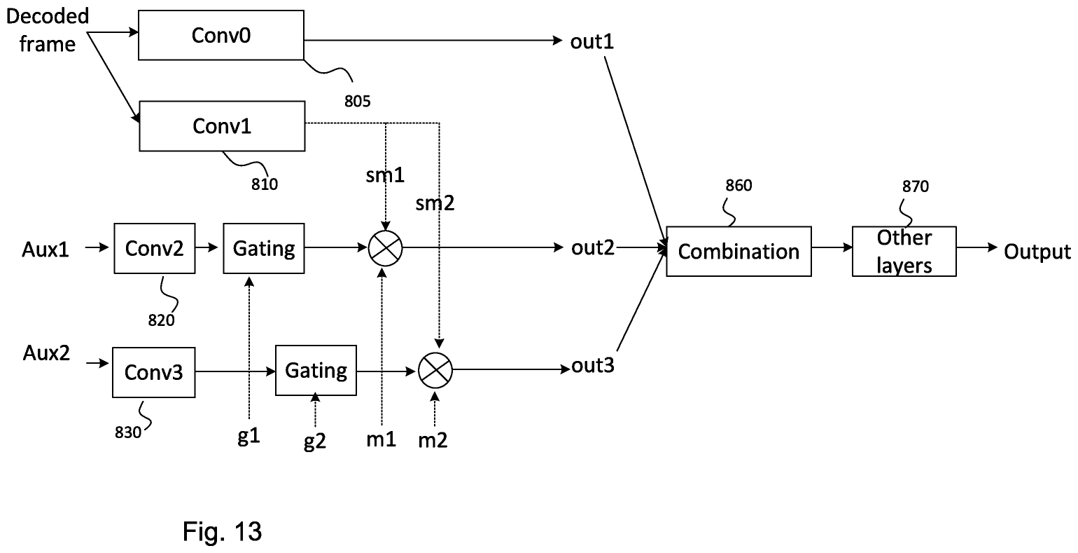

FIG. 13 illustrates an example implementation of the sixth embodiment, which is a combination of embodiment 1, embodiment 2 and embodiment 3. The encoder may signal information indicative of one or more gating flags and/or information indicative of one or more modulating values. Also, self-modulation may be performed by the NN filter.

The encoder may signal to the decoder an indication of whether to perform the gating, for example by signalling a binary flag referred to as enable_gating_flag. If this binary flag is set to 1, the encoder further signals the one or more gating flags, which are used by the decoder for performing the gating.

The encoder may signal to the decoder an indication of whether to perform the modulation by using one or more modulating values signaled by the encoder, for example by signaling a binary flag referred to as enable_encoder_modulation_flag. If this binary flag is set to 1, the encoder further signals the one or more modulating values, which are used by the decoder for performing the modulation operations.

The encoder may signal to the decoder an indication of whether to perform the self-modulation, for example, by signaling a binary flag referred to as enable_self_modulation_flag. If this binary flag is set to 1, the decoder applies self-modulation.

Thus, the gating, the self-modulating values and the modulating values are used for controlling the features extracted from Conv2 and Conv3, and thus they represent controlling values for the auxiliary features. It is appreciated that in some embodiment the controlling values are used for controlling the auxiliary data units.

The combination block 860 may combine its three inputs out1, out2, out3 into a signal. Thus, the signal comprises one or more sets of combined features. For example, the Combination block 860 may be a concatenation operation or a summation operation. Other layers 870, i.e., further portions of the NN based processor, represent a set of other NN layers in the NN filter, that are configured to process the combined outputs.

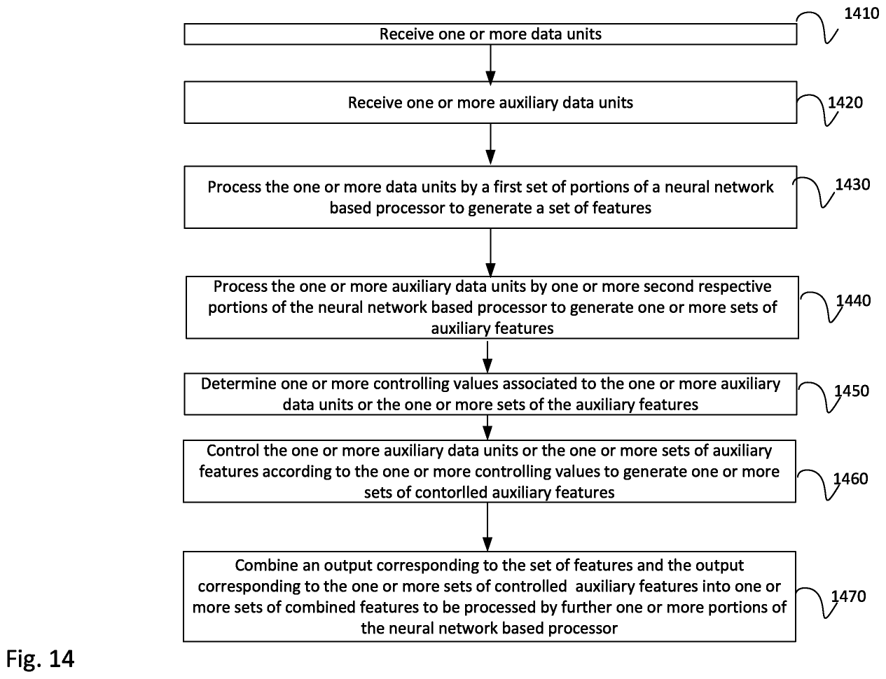

The method according to an embodiment is shown in FIG. 14. The method generally comprises receiving 1410 one or more data units; receiving 1420 one or more auxiliary data units; processing 1430 the one or more data units by a first portion of a neural network based processor to generate a set of features; processing 1440 the one or more auxiliary data units by one or more second respective portions of the neural network based processor to generate one or more sets of auxiliary features; determining 1450 one or more controlling values associated to the one or more auxiliary data units or to the one or more sets of auxiliary features; controlling 1460 the one or more auxiliary data units or the one or more sets of auxiliary features according to the one or more controlling values to generate one or more sets of controlled auxiliary features; and combining 1470 an output corresponding to the set of features and output corresponding to the one or more sets of controlled auxiliary features into one or more sets of combined features to be processed by further one or more portions of the neural network based processor. Each of the steps can be implemented by a respective module of a computer system.

An apparatus according to an embodiment comprises means for receiving one or more data units; means for receiving one or more auxiliary data units; means for processing the one or more data units by a first portion of a neural network based processor to generate a set of features; means for processing the one or more auxiliary data units by one or more second respective portions of the neural network based processor to generate one or more sets of auxiliary features; means for determining one or more controlling values associated to the one or more auxiliary data units or to the one or more sets of auxiliary features; means for controlling the one or more auxiliary data units or the one or more sets of auxiliary features according to the one or more controlling values to generate one or more sets of controlled auxiliary features; and means for combining an output corresponding to the set of features and output corresponding to the one or more sets of controlled auxiliary features into one or more sets of combined features to be processed by further one or more portions of the neural network based processor. The means comprises at least one processor, and a memory including a computer program code, wherein the processor may further comprise processor circuitry. The memory and the computer program code are configured to, with the at least one processor, cause the apparatus to perform the method of FIG. 14 according to various embodiments.

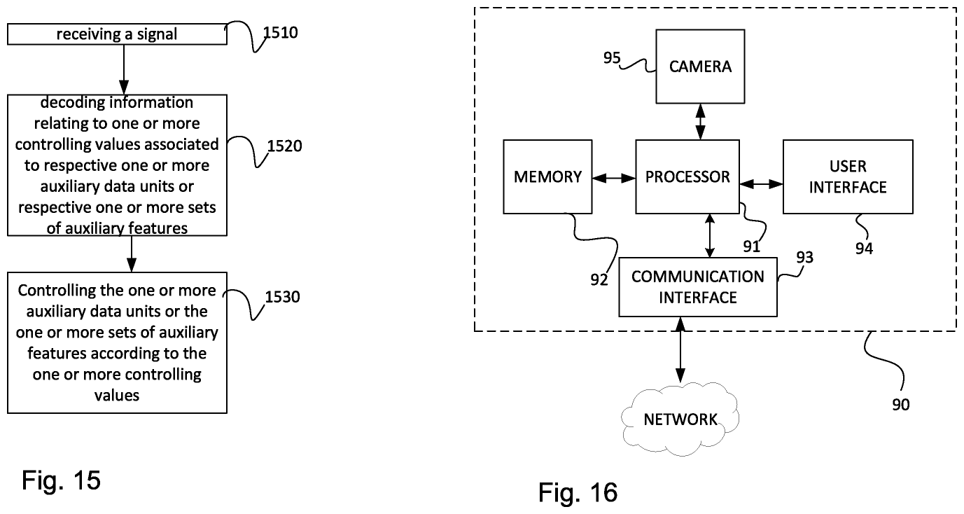

The method for decoding according to an embodiment is shown in FIG. 15. The method generally comprises receiving 1510 a signal; decoding 1520 information relating to one or more controlling values associated to respective one or more sets of auxiliary features; and controlling 1530 the one or more sets of auxiliary features according to the one or more controlling values. Each of the steps can be implemented by a respective module of a computer system.

An apparatus according to an embodiment comprises means for receiving a signal; means for decoding information relating to one or more controlling values associated to respective one or more sets of auxiliary features; and means for controlling the one or more sets of auxiliary features according to the one or more controlling values. The means comprises at least one processor, and a memory including a computer program code, wherein the processor may further comprise processor circuitry. The memory and the computer program code are configured to, with the at least one processor, cause the apparatus to perform the method of FIG. 15 according to various embodiments.

An example of an apparatus is shown in FIG. 16. The apparatus is a user equipment for the purposes of the present embodiments. The apparatus 90 comprises a main processing unit 91, a memory 92, a user interface 94, a communication interface 93.

The apparatus according to an embodiment, shown in FIG. 16, may also comprise a camera module 95. Alternatively, the apparatus may be configured to receive image and/or video data from an external camera device over a communication network. The memory 92 stores data including computer program code in the apparatus 90. The computer program code is configured to implement the method according to various embodiments by means of various computer modules. The camera module 95 or the communication interface 93 receives data, in the form of images or video stream, to be processed by the processor 91. The communication interface 93 forwards processed data, i.e., the image file, for example to a display of another device, such a virtual reality headset. When the apparatus 90 is a video source comprising the camera module 95, user inputs may be received from the user interface.

The various embodiments can be implemented with the help of computer program code that resides in a memory and causes the relevant apparatuses to carry out the method. For example, a device may comprise circuitry and electronics for handling, receiving and transmitting data, computer program code in a memory, and a processor that, when running the computer program code, causes the device to carry out the features of an embodiment. Yet further, a network device like a server may comprise circuitry and electronics for handling, receiving and transmitting data, computer program code in a memory, and a processor that, when running the computer program code, causes the network device to carry out the features of various embodiments.

If desired, the different functions discussed herein may be performed in a different order and/or concurrently with other. Furthermore, if desired, one or more of the above-described functions and embodiments may be optional or may be combined.

Although some embodiments have been described with reference to specific syntax structures or syntax elements, embodiments apply to any similar syntax structures or syntax elements. For example, embodiments described with reference to an SEI message apply to any syntax structures for carriage of supplemental information, such as a metadata OBU. Similarly, embodiments described with reference to an adaptation parameter set apply to any syntax structure for carriage of parameters, such as a header syntax structure (e.g., a sequence header or a picture header).

Although various aspects of the embodiments are set out in the independent claims, other aspects comprise other combinations of features from the described embodiments and/or the dependent claims with the features of the independent claims, and not solely the combinations explicitly set out in the claims.

It is also noted herein that while the above describes example embodiments, these descriptions should not be viewed in a limiting sense. Rather, there are several variations and modifications, which may be made without departing from the scope of the present disclosure as, defined in the appended claims.

1-16. (canceled)

17. An apparatus comprising: at least one processor; and at least one memory storing instructions that, when executed by the at least one processor, cause the apparatus at least to perform: receiving one or more data units; receiving one or more auxiliary data units; processing the one or more data units by a first portion of a neural network-based processor to generate a set of features; processing the one or more auxiliary data units by one or more second respective portions of the neural network based processor to generate one or more sets of auxiliary features; determining one or more controlling values associated to the one or more auxiliary data units or to the one or more sets of auxiliary features; controlling the one or more auxiliary data units or the one or more sets of auxiliary features according to the one or more controlling values to generate one or more sets of controlled auxiliary features; and combining an output corresponding to the set of features and output corresponding to the one or more sets of controlled auxiliary features into one or more sets of combined features to be processed by further one or more portions of the neural network based processor.

18. The apparatus according to claim 17, is further caused to perform: determining an optimal subset of the one or more auxiliary data units or the one or more sets of the auxiliary features for neural network-based processor.

19. The apparatus according to claim 18, is further caused to perform: indicating in a signal information relating to the optimal subset.

20. The apparatus according to claim 17, wherein the one or more controlling values comprise at least one or more binary flags or gating values being associated with respective one or more auxiliary data units or respective one or more sets of auxiliary features, where each of the one or more binary flags or gating values are used to gate the respective one or more auxiliary data units or respective one or more sets of auxiliary features.

21. The apparatus according to claim 20, wherein the one or more gating values comprise respective one or more identifiers, each indicating a set of auxiliary features to be used.

22. The apparatus according to claim 17, wherein the one or more controlling values comprise one or more modulating values associated with respective one or more auxiliary data units or respective one or more sets of auxiliary values.

23. The apparatus according to claim 22, is further caused to perform: determining at least some of the modulating values by the first portion of a neural network-based processor, or by a third portion of a neural network based processor whose input comprises the one or more data units.

24. The apparatus according to claim 22, wherein the one or more modulating values are comprised within a signal that is signaled from an encoder, and where the signal comprises one or more modulating values associated to respective one or more auxiliary data type; or pairs where each pair comprises an auxiliary data type and a respective modulating value; or an identifier of a set of modulating values.

25. The apparatus according to claim 22, is further caused to perform: inferring the modulating values from the previously (de)coded filtering units in current frame and/or reference frame.

26. The apparatus according to claim 19, is further caused to perform: including into a signal an indication of whether to perform gating and/or an indication of whether to perform modulation based on one or more modulating values determined based on a signal from an encoder and/or an indication of whether to perform modulation based on one or more modulating values determined at decoder side.

27. The apparatus according to claim 20, wherein the one or more gating values are comprised within a signal that is signaled from an encoder.

28. The apparatus according to claim 20, wherein the signal is comprised in a Supplemental Enhancement Information (SEI) message or in an Adaptation Parameter Set (APS).

29. The apparatus according to claim 17, is further caused to perform: generating a signal comprising information relating to the one or more controlling values.

30. An apparatus comprising: at least one processor; and at least one memory storing instructions that, when executed by the at least one processor, cause the apparatus at least to perform: receiving a signal; decoding information relating to one or more controlling values associated to respective one or more auxiliary data units or respective one or more sets of auxiliary features; and controlling the one or more auxiliary data units or the one or more sets of auxiliary features according to the one or more controlling values.

31. A method comprising: receiving one or more data units; receiving one or more auxiliary data units; processing the one or more data units by a first portion of a neural network-based processor to generate a set of features; processing the one or more auxiliary data units by one or more second respective portions of the neural network-based processor to generate one or more sets of auxiliary features; determining one or more controlling values associated to the one or more auxiliary data units or to the one or more sets of auxiliary features; controlling the one or more auxiliary data units or the one or more sets of auxiliary features according to the one or more controlling values to generate one or more sets of controlled auxiliary features; and combining an output corresponding to the set of features and output corresponding to the one or more sets of controlled auxiliary features into one or more sets of combined features to be processed by further one or more portions of the neural network-based processor.

32. The method according to claim 31, further comprising: determining an optimal subset of the one or more auxiliary data units or the one or more sets of the auxiliary features for neural network-based processor.

33. The method according to claim 32, further comprising: indicating in a signal information relating to the optimal subset.

34. The method according to claim 31, wherein the one or more controlling values comprise at least one or more binary flags or gating values being associated with respective one or more auxiliary data units or respective one or more sets of auxiliary features, where each of the one or more binary flags or gating values are used to gate the respective one or more auxiliary data units or respective one or more sets of auxiliary features.

35. The method according to claim 34, wherein the one or more gating values comprise respective one or more identifiers, each indicating a set of auxiliary features to be used.

36. The method according to claim 31, wherein the one or more controlling values comprise one or more modulating values associated with respective one or more auxiliary data units or respective one or more sets of auxiliary values.
